(19) United States
(12) Patent Application Publication
(10) Pub. No.: US 2019/0234654 A1
(43) Pub. Date: Aug. 1, 2019

(54) WATER HEATER AND HEAT EXCHANGER USING PLANAR HEATING ELEMENT

(71) Applicant: ArkWaveSolutions Korea Co., Ltd., Seoul (KR)

(72) Inventor: Hee Bock LEE, Jeonju-si (KR)

(21) Appl. No.: 16/330,824

(22) PCT Filed: Dec. 8, 2016
(86) PCT No.: PCT/KR2016/014373

§ 371 Date: Mar. 6, 2019

(30) Foreign Application Priority Data
Sep. 7, 2016 (KR) 10-2016-0115176
Sep. 7, 2016 (KR) 10-2016-0115180
Sep. 7, 2016 (KR) 10-2016-0115181
Sep. 28, 2016 (KR) 10-2016-0124671

(51) Int. Cl. F24H 1/10; H05B 3/14; H05B 3/46

(52) U.S. Cl. CPC F24H 1/103; F24H 1/106; F24H 2250/02; H05B 3/46; H05B 3/145

(57) ABSTRACT

A water heater using a planar heating element according to the embodiment of the present invention comprises a planar heating pipe coated with a planar heating material; a hot water tank including an upper surface coupled with the planar heating pipe where a first hole and a second hole are formed, a side surface surrounding an outside of the planar heating pipe where an outlet is formed, and an open lower surface; a first header provided at the upper surface to form a first housing; and a second header provided at the other end of the planar heating pipe and the open lower surface to form a second hosing where an inlet coupled with the other end of the planar heating pipe is formed. Wherein the first housing is a space defined by an inner surface of the first header and the upper surface of the hot water tank, and the second housing is a space defined by an outer surface of the planar heating pipe, an inner surface of the hot water tank, and an inner surface of the second head.

### CROSS-REFERENCE TO RELATED APPLICATIONS

This application claims the benefit under 35 U.S.C. § 371, of PCT International Application No. PCT/KR2016/014373 filed on Dec. 8, 2016, which claimed priority to Korean Patent Application No. 10-2016-0115176 filed on Sep. 7, 2016, Korean Patent Application No. 10-2016-0115180 filed on Sep. 7, 2016, Korean Patent Application No. 10-2016-0115181 filed on Sep. 7, 2016, and Korean Patent Application No. 10-2016-0124671 filed on Sep. 28, 2016 in the Korean Intellectual Property Office, the entire contents of which are hereby incorporated by reference.

### TECHNICAL FIELD

The present invention relates to a water heater and a heat exchanger which include a pipe using a planar heating element.

### BACKGROUND ART

A planar heating element generates heat by electric resistance when electricity is applied to the heating element of carbon material. In general, the planar heating element has superior thermal efficiency and excellent durability as compared with an alloy-based heat conductive element. To this end, efforts have been made to develop a water heater using the planar heating element.

### DISCLOSURE OF INVENTION

### Technical Problem

An object of the present invention is to provide a water heater and a heat exchanger using a planar heating element, which is easy to manufacture and has an improved thermal efficiency.

An object of the present invention is to provide a water heater and a heat exchanger using a planar heating element, which has an enhanced far-infrared radiation effect.

### Solution to Problem

According to an embodiment of the present invention, a water heat using a planar heating element includes a planar heating pipe coated with a planar heating material, a hot water tank including an upper surface coupled with the planar heating pipe, where a first hole and a second hole are formed, a side surface surrounding an outside of the planar heating pipe, where an outlet is formed, and an opened lower surface, a first header provided at the upper surface to form a first housing, and a second header provided at the other end of the planar heating pipe and the opened lower surface to form a second hosing, where an inlet coupled with the other end of the planar heating pipe is formed. The first housing may be a space defined by an inner surface of the first header and the upper surface of the hot water tank, and the second housing may be a space defined by an outer surface of the planar heating pipe, an inner surface of the hot water tank, and an inner surface of the second head.

### Advantageous Effects of Invention

According to an embodiment of the present invention, a water heater and a heat exchanger using a planar heating element, which is easy to manufacture and has an improved thermal efficiency.

According to an embodiment of the present invention, a water heater and a heat exchanger using a planar heating element having an enhanced far-infrared radiation effect.

### BRIEF DESCRIPTION OF THE DRAWINGS

FIG. 1 is a view illustrating an electric heater using a planar heating element according to an embodiment of the present invention;

FIG. 2 is a view illustrating an electric heater 200 using a planar heating material according to an embodiment of the present invention;

FIG. 3 is a plan view taken along a line A-A′ of the electric heater 200 using the planar heating material illustrated in FIG. 2;

FIG. 4 is a view illustrating an electric heater 300 using a planar heating material according to an embodiment of the present invention;

FIG. 5 is a plan view taken along a line A-A′ of the electric heater 300 using the planar heating material illustrated in FIG. 4;

FIG. 6 is a cross-sectional view taken along a line B-B′ of the electric heater 300 using the planar heating material illustrated in FIG. 5;

FIG. 7 is a cross-sectional view taken along a line C-C′ of the electric heater 300 using the planar heating material illustrated in FIG. 5;

FIG. 8 is a view illustrating an electric heater 400 using a planar heating material according to an embodiment of the present invention;

FIG. 9 is a plan view of the electric heater 400 using the planar heating material illustrated in FIG. 8;

FIG. 10 is a detailed view illustrating a planar heating pipe 500 according to an embodiment of the present invention;

FIG. 11 is a plan view taken along a line D-D′ of the planar heating pipe 500 illustrated in FIG. 10;

FIG. 12 is a cross-sectional view taken along a line E-E′ of the planar heating pipe 500 illustrated in FIG. 11;

FIG. 13 is a detailed view illustrating another example of a planar heating pipe 600 according to an embodiment of the present invention;

FIG. 14 is a plan view of the planar heating pipe 600 illustrated in FIG. 13;

FIG. 15 is a cross-sectional view taken along a line F-F′ of the planar heating pipe 600 illustrated in FIG. 14;

FIG. 16 is a cross-sectional view taken along a line G-G′ of the planar heating pipe 600 illustrated in FIG. 14;

FIG. 17 is a detailed view illustrating another example of a planar heating pipe 700 according to an embodiment of the present invention;

FIG. 18 is a plan view of the planar heating pipe 700 illustrated in FIG. 17;

FIG. 19 is a cross-sectional view taken along a line J-J′ of the planar heating pipe 700 illustrated in FIG. 18;

FIG. 20 is a view illustrating a water heater 1000 using a planar heating element according to an embodiment of the present invention;

FIG. 21 is a view illustrating a schematic operation of the water heater 1000 using the planar heating element according to an embodiment of the present invention;

FIG. 22 is a view illustrating a heat exchanger using a planar heating element according to an embodiment of the present invention;

FIG. 23 is a detailed view illustrating a first connection part 2200 illustrated in FIG. 22;

FIG. 24 is a detailed view illustrating a second connection part 2300 illustrated in FIG. 22;

FIG. 25 is a view illustrating one side of the heat exchanger 2000 using the planar heating element illustrated in FIG. 22; and

FIG. 26 is a view illustrating one side of the heat exchanger 2000 using the planar heating element illustrated in FIG. 22.

### BEST MOD FOR CARRYING OUT THE INVENTION

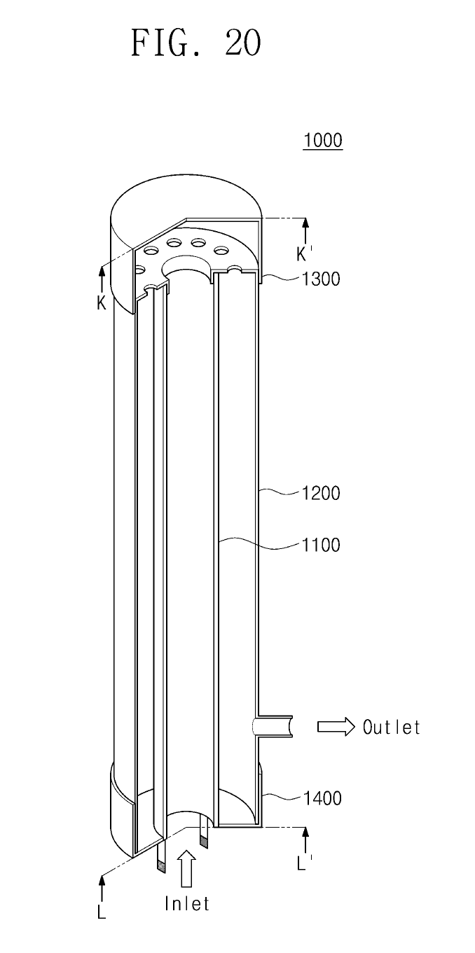

FIG. 20 is a view illustrating the best mode for carrying out the present invention.

### DESCRIPTION OF EMBODIMENTS

Hereinafter, embodiments of the present invention will be described clearly and in detail with reference to the accompanying drawings to be easily carried out by those skilled in the art (hereinafter, an ordinary technician).

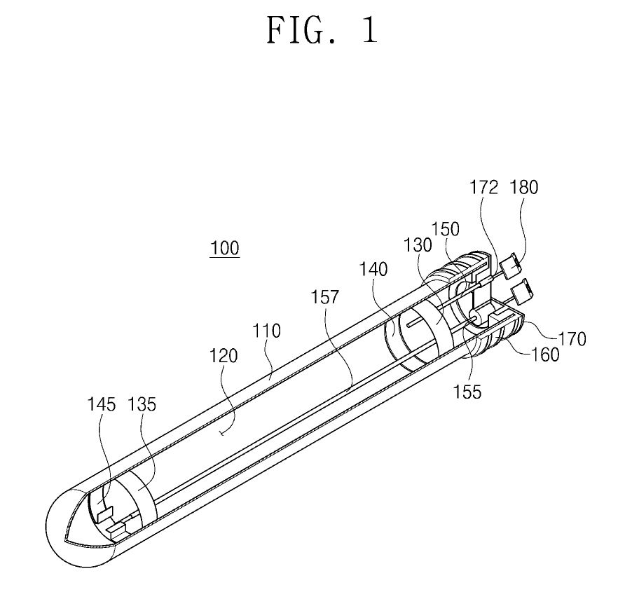

FIG. 1 is a view illustrating an electric heater using a planar heating element according to an embodiment of the present invention. Referring to FIG. 1, the electric heater 100 using the planar heating element may include a heat transfer pipe 110, a planar heating material 120, first and second electrode strips 130 and 135, first and second snap rings 140 and 145, first and second conductive lines 150 and 155, a sealing adhesive frame 160, and a sealing header 170.

The heat transfer pipe 110 may include a material having a high thermal conductivity. For example, the heat transfer pipe 110 may be formed of glass. However, the material of the heat transfer pipe 110 is not limited thereto, and the heat transfer pipe 110 may be formed of a plastic having a high thermal conductivity (e.g., a heat-dissipating plastic). One end of the heat transfer pipe 110 may be closed, and the other end may be opened. For example, as illustrated in FIG. 1, one end of the heat transfer pipe 110 may be closed in a hemispherical shape.

An outside of the heat transfer pipe 110 is coated with a ceramic material. For example, the ceramic material may include silica (SiO₂), isopropyl alcohol (IPA), distilled water (H₂O), zirconia (ZrO₂), a black inorganic pigment (e.g., CuO₂, CrO₂), a white inorganic pigment (e.g., TiO₂), or mixtures thereof. For example, the ceramic material may include silica (SiO₂) of 30 to 40 wt %, isopropyl alcohol (IPA) of 15 to 25 wt %, distilled water (H₂O) of 15 to 20 wt %, zirconia (ZrO₂) of 5 to 7 wt %, the black inorganic pigment (e.g., CuO₂, CrO₂) 3 to 5 wt %, and the white inorganic pigment (e.g., TiO₂) of 10 to 15 wt %. A sum of composition ratios of respective materials may not exceed 100 wt %. However, when the ceramic material includes a material other than the above-mentioned compositions, the sum of the composition ratios of the above-mentioned compositions may be less than 100 wt %.

The planar heating material 120 may be coated at an inside of the heat transfer pipe 110. The planar heating material 120 may not be coated at an entire inside of the heat transfer pipe 110 and may be coated at a part of the heat transfer pipe 110 to be electrically connected to the first and second electrode strips 130 and 135. For example, the planar heating material 120 may include metal powder, carbon black, carbon powder, graphite powder, or various combinations thereof. When the planar heating material 120 include a mixture thereof, the planar heating material 120 may further include a binder, a hardener, a dispersing agent, and a solvent.

The binder may properly bind at least one of metal powder, carbon black, carbon powder, and graphite powder, the dispersing agent, the hardener, and the like to one another. For example, the binder may include a water-soluble material or may include acrylic, urethane, epoxy, silicone, and the like.

The hardener may improve hardness of the planar heating material 120 coated at the inside of the heat transfer pipe 110. For example, the hardener may include organic peroxide, isocyanate, azo dyes, amine, amidazole, and the like. However, the hardener is not limited thereto, and may include various materials capable of improving hardness of the planar heating material 120.

The dispersing agent may appropriately disperse at least one of metal powder, carbon black, carbon powder, and graphite powder, and the binder to evenly distribute them. For example, the dispersing agent may be an adsorbing substance such as a surfactant, a polymer substance, a peptizer, or the like. However, not limited thereto, various materials which prevent particles from aggregating may be used.

The solvent may be used to adjust a concentration of the binder. The solvent may include at least one of ethanol, methanol, methyl ethyl ketone (MEK), methyl isobutyl ketone (MIBK), and toluene, and may be a volatile substance. The solvent may be evaporated or incinerated in the process of drying the planar heating material 120.

The first and second electrode strips 130 and 135 may be provided at both ends of the planar heating material 120 so that a current applied from the outside flows through the planar heating material 120. For example, the first and second electrode strips 130 and 135 may be formed of a silver paste and may be coated at both ends of the planar heating material 120, respectively.

The first and second snap rings 140 and 145 may be disposed on the first and second electrode strips 130 and 135, respectively. The first and second snap rings 140 and 145 may include a conductive material. Accordingly, the first snap ring 140 may be electrically connected to the first electrode strip 130, and the second snap ring 145 may be electrically connected to the second electrode strip 135.

One ends of the first and second conductive lines 150 and 155 may be connected to the first and second snap rings 140 and 145, respectively. The other ends of the first and second conductive lines 150 and 155 may be extended to one open end of the heat transfer pipe 110. For example, electricity may be supplied from the outside through the extended first and second conductive lines 150 and 155.

A casing pipe 157 may be provided to insulate the second conductive line 155. For example, the casing pipe 157 may include an insulating material. For example, the second conductive line 155 may be formed to surround a remaining portion except a portion where the second conductive line 155 contacts the second snap ring 145. Although only the casing pipe 157 surrounding the second conductive line 155 is shown in the drawing, a casing pipe surrounding the first conductive line 150 may be further provided. Alternatively, according to an embodiment, the casing pipe 157 may not be provided.

The sealing adhesive frame 160 and the sealing header 170 may be provided for sealing the heat transfer pipe 110. For example, the sealing adhesive frame 160 and the sealing header 170 may be provided at one open end of the heat transfer pipe 110. The sealing adhesive frame 160 may allow the heat transfer pipe 110 to be completely sealed by the sealing header 170. For example, the sealing adhesive frame 160 may include rubber or silicone. The sealing adhesive frame 160 may be made of a material capable of withstanding a high temperature when the electric heater 100 using the planar heating element generates heat. The sealing header 170 may be made of a plastic, but is not limited thereto. For example, the sealing header 170 may be composed of various elements including an insulating material.

A sealing adhesive 172 may completely adhere the sealing header 170 to the first and second conductive lines 150 and 155.

Terminals 180 may be provided at both ends of the first and second conductive lines 150 and 155, respectively. The two terminals 180 may each be connected to different electrodes. For example, one terminal connected to the first conductive line 150 may be connected to a positive electrode, and the other terminal connected to the second conductive line 155 may be connected to a negative electrode.

According to this embodiment, the amount of heat generated by the electric heater 100 using the planar heating material may be freely adjusted. For example, when a distance between the first and second snap rings 140 and 145 decreases to closely arrange the first and second snap rings 140 and 145, the heat capacity of the electric heater 100 may decrease. On the contrary, when the distance between the first and second snap rings 140 and 145 increases to far arrange the first and second snap rings 140 and 145, the heat capacity of the electric heater 100 may increase. The first and second electrode strips 130 and 135 may be properly coated so that electricity may flow although the first and second snap rings 140 and 145 are disposed at any positions.

The configuration of the electric heater 100 using the planar heating material according to the embodiment of the present invention has been schematically described above. The electricity applied through the terminal 180 connected to the first conductive line 150 may flow through the first conductive line 150, the first snap ring 140, the first electrode strip 130, the planar heating material 120, the second electrode strip 135, the second snap ring 145, and the second conductive line 155. At this time, a radiation body (e.g., the heat transfer pipe 110) may be heated by conduction heat caused by a current flowing through the planar heating material 120. Further, far infrared ray may be radiated from the heated radiation body, and the ceramic material coated at the outside of the heat transfer pipe 110 may improve far infrared ray generation efficiency.

The electric heater 100 using the planar heating material according to the embodiment of the present invention may be used for various purposes. For example, the electric heater 100 using the planar heating material may be detachably provided to a water tank, and may be used to heat water in the water tank. For example, in this case, only the heat transfer pipe 110 of the electric heater 100 using the planar heating material may be arranged to be in contact with water. In addition, the electric heater 100 using the planar heating material may be applied to various applications such as a heater, a hot air fan, and the like.

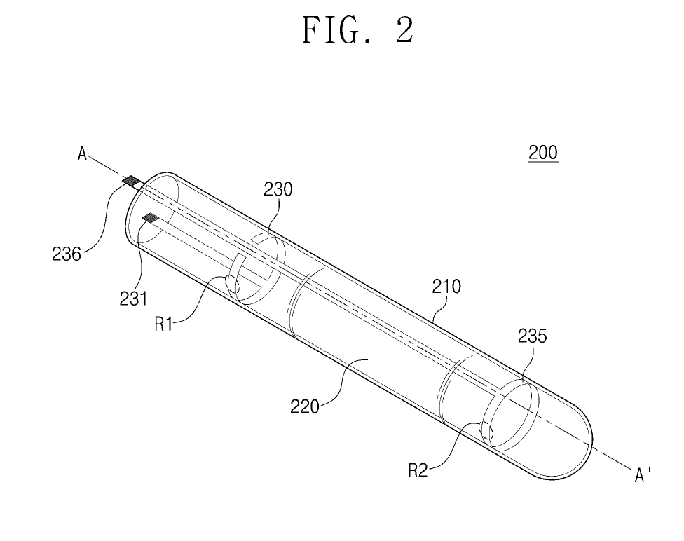

FIG. 2 is a view illustrating an electric heater 200 using a planar heating material according to an embodiment of the present invention. FIG. 2, the electric heater 200 using a planar heating material may include a heat transfer pipe 210, a planar heating material 220, and first and second electrode strips 230 and 235.

As shown in FIG. 2, one end of the heat transfer pipe 210 may be closed and the other end thereof may be opened. The heat transfer pipe 210 may include a material having a high thermal conductivity. For example, the heat transfer pipe 210 may be formed of glass. However, the material included in the heat transfer pipe 210 is not limited thereto, and the heat transfer pipe 210 may be made of a plastic (e.g., a heat-dissipating plastic) having a high thermal conductivity.

An outer surface of the heat transfer pipe 210 may be coated with a ceramic material. Types and composition ratios of the ceramic material have been described in detail in FIG. 1. Therefore, a repeated description will be omitted.

The planar heating material 220 may be coated at an inside of the heat transfer pipe 210. For example, the planar heating material 220 may include metal powder, carbon black, carbon powder, graphite powder, or various combinations thereof. On the other hand, when the planar heating material 220 is a mixture thereof, the planar heating material 220 may further include a binder, a hardener, a dispersant, and a solvent. Since these materials included in the planar heating material 220 have been described in detail with reference to FIG. 1, a repeated description will be omitted.

The first and second electrode strips 230 and 235 may be provided at both ends of the planar heating material 220 so that a current applied from the outside may flow through the planar heating material 220. For example, the first and second electrode strips 230 and 235 may be formed of a silver paste and may be coated at the both ends of the planar heating material 220, respectively.

As shown in FIG. 2, the first electrode strip 230 may include a broken ring (discontinuous ring) R1. This is to prevent the first electrode strip 230 and the second electrode strip 235 from being electrically short-circuited. The first electrode strip 230 may include a strip connecting the broken ring R1 to the outside of the heat transfer pipe 210. However, according to an embodiment, the first electrode strip 230 may include an unbroken ring or a continuous ring. In this case, an insulating material or the like for preventing the first electrode strip 230 and the second electrode strip 235 from being electrically short-circuited may be additionally provided between the first electrode strip 230 and the second electrode strip 235.

The second electrode strip 235 may include an unbroken ring or a continuous ring R2. The second electrode strip 235 may be properly formed in the heat transfer pipe 210 so as not to be electrically short-circuited with the first electrode strip 230. Also, the second electrode strip 235 may include a strip connecting the ring R2 and the outside of the heat transfer pipe 210. For example, a length of the strip connecting the ring R2 of the second electrode strip 235 to the outside may be longer than a length of the strip connecting the ring R1 of the first electrode strip 230 to the outside.

First and second terminals 231 and 236 may be formed at one ends of the first and second electrode strips 230 and 235, respectively. For example, the first terminal 231 may be connected to a positive electrode, and the second terminal 236 may be connected to a negative electrode.

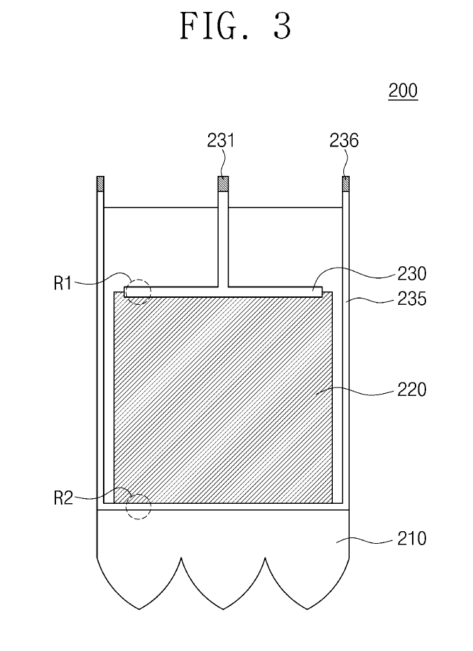

FIG. 3 is a plan view taken along a line A-A′ of the electric heater 200 using the planar heating material shown in FIG. 2. For the sake of simplicity of the illustration, the electric heater 200 using the planar heating material is cut along the line A-A′, and the electric heater 200 using the planar heating material is shown as being flattened. That is, the heat transfer pipe 210 shown in FIG. 3 may actually illustrate an inner surface of the heat transfer pipe 210. In accordance with this illustration, the first electrode strip 230 is shown to have a “T” shape. Also, since the second electrode strip 235 is also cut along the line A-A′, the second electrode strip 235 is shown to have an angular U-shape.

Upon operation of the electric heater 200 using the planar heating material, one current path for electrically connecting the first electrode strip 230, the planar heating material 220, and the second electrode strip 235 to one another may be formed. To form this current path, the first terminal 231 may be connected to a positive electrode and the second terminal 236 may be connected to a negative electrode.

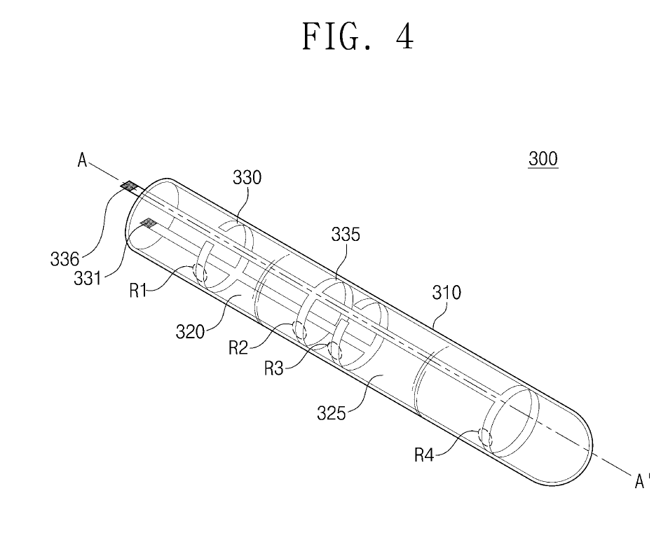

FIG. 4 is a view illustrating an electric heater 300 using a planar heating material according to an embodiment of the present invention. Referring to FIG. 4, the electric heater 300 using the planar heating material includes a heat transfer pipe 310, first and second planar heating materials 320 and 325, and first and second electrode strips 330 and 335.

As shown in FIG. 4, one end of the heat transfer pipe 310 may be closed and the other end thereof may be opened. The heat transfer pipe 310 may include a material having a high thermal conductivity. For example, the heat transfer pipe 310 may be formed of glass. However, the material of the heat transfer pipe 310 is not limited thereto, and the heat transfer pipe 310 may be made of a plastic (e.g., heat-dissipating plastic) having a high thermal conductivity.

An outside of the heat transfer pipe 310 may be coated with a ceramic material. Types and composition ratios of the ceramic material have been described in detail with reference to FIG. 1, and a detailed description thereof will be omitted.

The first and second planar heating materials 320 and 325 may be coated at an inside of the heat transfer pipe 310. For example, the first and second planar heating materials 320 and 325 may include metal powder, carbon black, carbon powder, graphite powder, or various combinations thereof. These materials included in the first and second planar heating materials 320 and 325 have been described in detail with reference to FIG. 1, and a repeated description thereof will be omitted.

The first and second electrode strips 330 and 335 may be provided at both ends of the first and second planar heating materials 320 and 325 so that a current applied from the outside is capable of flowing through the first and second planar heating materials 320 and 325, respectively. For example, the first and second electrode strips 330 and 335 may be formed of a silver paste.

As shown in FIG. 4, the first electrode strip 330 may include two rings R1 and R3. For example, the rings R1 and R3 may be broken rings (discontinuous rings), which may prevent the first electrode strip 330 and the second electrode strip 335 from being electrically short-circuited. Alternatively, according to an embodiment, the rings Ri and R3 may be unbroken rings or continuous rings. In this case, an insulating material may be further provided to prevent the first electrode strip 330 and the second electrode strip 335 from being short-circuited. For example, such an insulating material may be provided at a portion where the first electrode strip 330 and the second electrode strip 335 are overlapped.

The second electrode strip 335 may include two rings R2, R4. For example, the rings R2 and R4 may be unbroken rings or continuous rings. However, when the ring R2 is not cut, an insulating material may be further provided to prevent the first electrode strip 330 and the second electrode strip 335 from being electrically short-circuited. For example, the insulating material may be provided at a portion where the first electrode strip 330 and the ring R2 are overlapped. Alternatively, according to an embodiment, ring R2 may be a broken ring (or a discontinuous ring). In this case, since the first electrode strip 330 and the second electrode strip 335 are properly arranged not to be electrically short-circuited, an additional insulating material may not be required.

The first electrode strip 330 may include a strip connecting the rings R1 and R3 to the outside of the heat transfer pipe 310. The second electrode strip 335 may include a strip connecting the rings R2 and R4 to the outside of the heat transfer pipe 310. A length of the strip connecting the rings R2 and R4 to the outside of the heat transfer pipe 310 may be longer than a length of the strip connecting the rings R1 and R3 to the outside of the heat transfer pipe 310.

First and second terminals 331 and 336 may be formed at one ends of the first and second electrode strips 330 and 335, respectively. For example, the first terminal 331 may be connected to a positive electrode, and the second terminal 336 may be connected to a negative electrode.

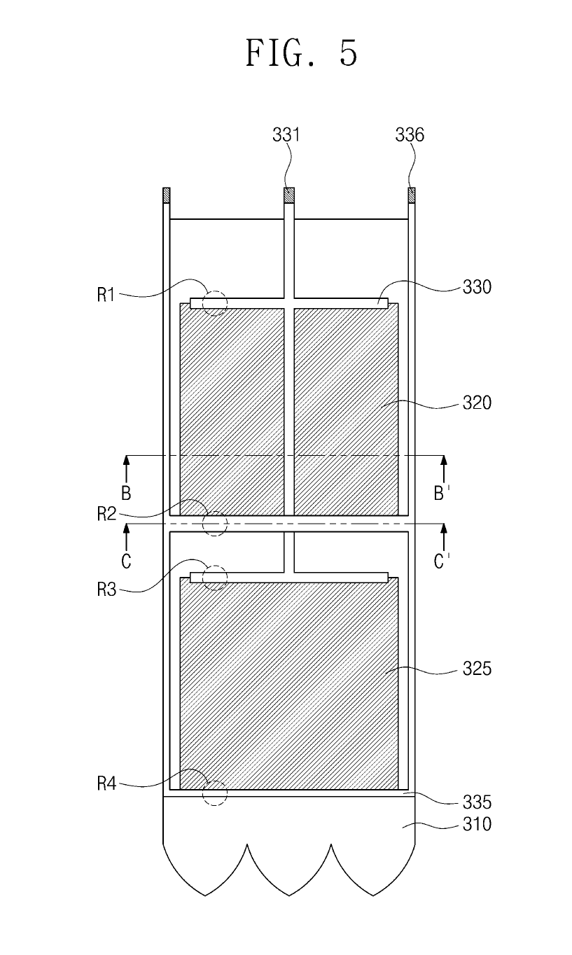

FIG. 5 is a plan view taken along a line A-A′ of the electric heater 300 using the planar heating material illustrated in FIG. 4. For the sake of simplicity of the illustration, the electric heater 300 using the planar heating material is cut along the line A-A′, and then the electric heater 300 using the planar heating material is shown as flattened. That is, the heat transfer pipe 310 shown in FIG. 4 may actually be an inner surface of the heat transfer pipe 310.

When the electric heater 300 using the planar heating material is operated, one path for electrically connecting the ring R1 of the first electrode strip 330, the first planar heating material 320, and the ring R2 of the second electrode strip 335 to one another may be formed. At the same time, another path for electrically connecting the ring R3 of the first electrode strip 330, the second planar heating material 325, and the ring R4 of the second electrode strip 335 to one another may be formed. To form these current paths, the first terminal 331 may be connected to a positive electrode and the second terminal 336 may be connected to a negative electrode.

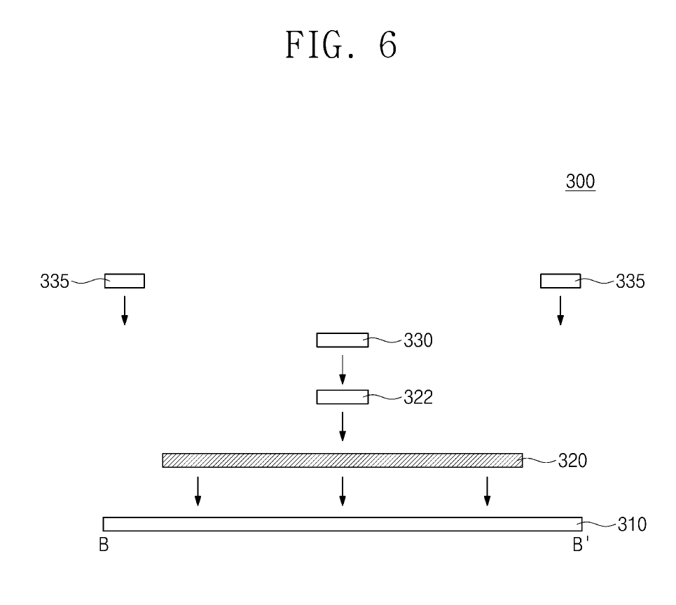

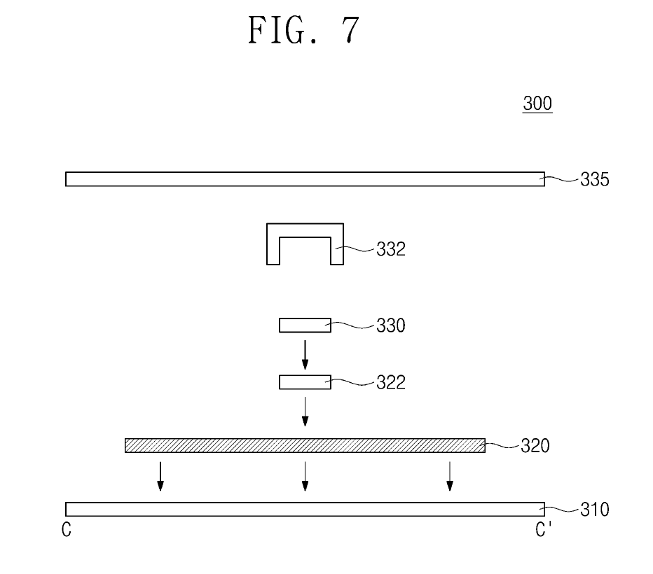

FIG. 6 is a cross-sectional view taken along a line B-B′ of the electric heater 300 using the planar heating material illustrated in FIG. 5. FIG. 7 is a cross-sectional view taken along a line C-C′ of the electric heater 300 using the planar heating material illustrated in FIG. 5. To help the understanding of explanation, the description will be made with reference to FIG. 6 and FIG. 7 together with FIG. 5.

The first planar heating material 320 may be coated at the inside of the heat transfer pipe 310. The heat transfer pipe 310 is flattened after the heat transfer pipe 310 is cut along the cutting direction so that the heat transfer pipe 310 is shown as being flat in the drawing. Therefore, the first planar heating material 320 may be actually coated at the inner surface of the heat transfer pipe 310.

An insulating material 322 may be coated on the first planar heating material 320. This is to electrically isolate the first planar heating material 320 from the strip except for the rings R1 and R2 of the first electrode strip 330. The ring R1 of the first electrode strip 330 may be directly coated on the first planar heating material 320. Alternatively, according to an embodiment, the insulating material 320 may not be provided. In this case, both the ring R1 of the first electrode strip 330 and the strip may be directly coated on the first planar heating material 320.

The first electrode strip 330 may be coated on the first planar heating material 320 or the insulating material 322. For example, the ring R1 of the first electrode strip 330 may be directly coated on the first planar heating material 320. For example, the ring R3 of the first electrode strip 330 may be directly coated on the second planar heating material 325. In addition, a strip other than the rings R1 and R3 of the first electrode strip 330 may be coated at the first planar heating material 320, the insulating material 322, or the inner surface of the heat transfer pipe 310.

The second electrode strip 335 may be coated the inside of the heat transfer pipe 310. For example, the ring R2 of the second electrode strip 335 may be coated on the first planar heating material 320 or the insulating material 322. The ring R4 of the second electrode strip 335 may be directly coated on the second planar heating material 325. However, when this coating method is carried out, in a plan viewpoint, the first electrode strip 330 should be not electrically short-circuited to the second electrode strip 335 at a portion where the first electrode strip 330 and the second electrode strip 335 are overlapped. For this, as illustrated in FIG. 7, the insulating material 332 may be additionally provided on the first electrode strip 330.

The electric heater 300 using the planar heating material described with reference to FIGS. 4 to 7 may be used for various purposes. For example, the electric heater 300 using the planar heating material may be detachably provided to a water tank, and may be used to heat water in the water tank. For example, in this case, only the heat transfer pipe 310 of the electric heater 300 using the planar heating material may be arranged to be in contact with water. According to this embodiment, it is possible to achieve the same effect as implementing two planar heating elements in one heat transfer pipe. In addition, unlike the embodiment described with reference to FIG. 1, forming the first and second electrode strips 330 and 335 through the coating method prevents an electrical short circuit and the manufacturing thereof is easy.

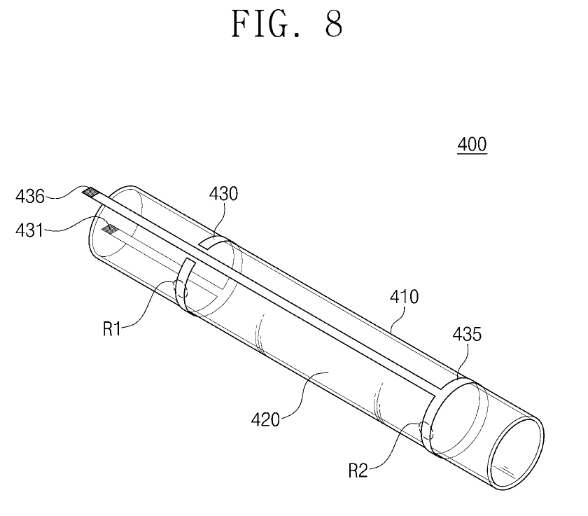

FIG. 8 is a view illustrating an electric heater 400 using a planar heating material according to an embodiment of the present invention. Referring to FIG. 8, the electric heater 400 using the planar heating material may include a heat transfer pipe 310, a planar heating material 420, and first and second electrode strips 430 and 435.

The heat transfer pipe 410 may have a pipe shape in which both ends are opened as shown in FIG. 8. The heat transfer pipe 410 may include a material having a high thermal conductivity. For example, the heat transfer pipe 410 may be formed of glass. However, the material included in the heat transfer pipe 410 is not limited thereto, and the heat transfer pipe 410 may be made of a plastic having a high thermal conductivity (e.g., a heat dissipating plastic).

An inside of the heat transfer pipe 410 may be coated with a ceramic material. Since types and composition ratios of the ceramic material have been described in detail with reference to FIG. 2, a repeated description will be omitted.

The planar heating material 420 may be coated at an outside of the heat transfer pipe 410. For example, the planar heating material 420 may include metal, carbon black, carbon, graphite, or various combinations thereof. These materials included in the planar heating material 420 have been described in detail with reference to FIG. 1, and a repeated description thereof will be omitted.

The first and second electrode strips 430 and 435 may be provided at both ends of the planar heating material 420 so that a current applied from the outside flows through the planar heating material 420. For example, the ring R1 of the first electrode strip 430 may be provided at one end of the planar heating material 420, and the ring R2 of the second electrode strip 435 may be provided at the other end of the planar heating material 420. For example, the first and second electrode strips 430 and 435 may be formed of a silver paste.

The first electrode strip 430 may include a broken ring (or a discontinuous ring) R1. This is to prevent the first electrode strip 430 and the second electrode strip 435 from being electrically short-circuited. The first electrode strip 430 may include a strip connecting the broken ring R1 to the outside of the heat transfer pipe 410. However, according to an embodiment, the first electrode strip 430 may include an unbroken ring or a continuous ring. In this case, an insulating material or the like for preventing the first electrode strip 430 and the second electrode strip 435 from electrically short-circuited may be further provided at a portion where the first electrode strip 430 and the second electrode strip 435 strip are overlapped.

The second electrode strip 435 may include an unbroken ring or a continuous ring R2. The second electrode strip 435 may be appropriately formed in the heat transfer pipes 410 not to be electrically short-circuited with the first electrode strip 430. In addition, the second electrode strip 435 may include a strip connecting the ring R2 to the outside of the heat transfer pipe 410. For example, a length of the strip connecting the ring R2 of the second electrode strip 435 to the outside may be longer than a length of the strip connecting the ring R1 of the first electrode strip 430 to the outside.

First and second terminals 431 and 436 may be formed at one ends of the first and second electrode strips 430 and 435, respectively. For example, the first terminal 431 may be connected to a positive electrode, and the second terminal 436 may be connected to a negative electrode.

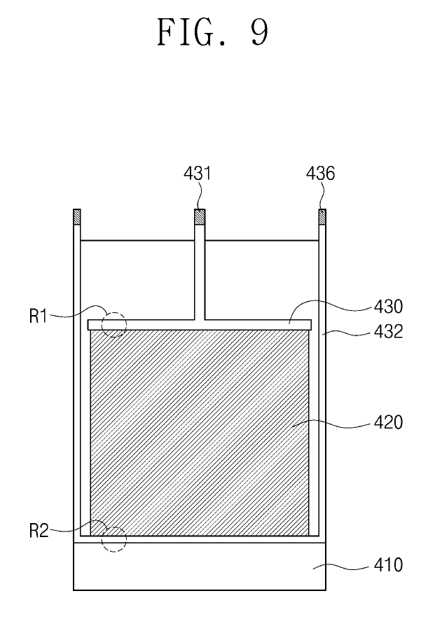

FIG. 9 is a plan view of the electric heater 400 using the planar heating material illustrated in FIG. 8. For the sake of simplicity of the illustration, the line A-A′ shown in FIG. 2 has not been shown. However, FIG. 9 shows a flattened side after being cut in a manner similar to that shown in FIG. 2. FIG. 9 may show an outer surface of a heat transfer pipe 410 unlike the heat transfer pipe 210 and 310 illustrated in FIGS. 3 and 5, which show the inner surface of the heat transfer pipes 210 and 310. According to this illustration, the first electrode strip 430 is shown to have a “T” shape and the second electrode strip 435 is shown to have an angular “U” shape.

Upon operation of the electric heater 400 using the planar heating material, one current path electrically connecting the first electrode strip 430, the planar heating material 420, and the second electrode strip 435 to one another may be formed. In order to form this current path, the first terminal 431 may be connected to a positive electrode and the second terminal 436 may be connected to a negative electrode.

The electric heater 400 using the planar heating material described above with reference to FIGS. 8 and 9 may be used for various purposes. For example, the electric heater 400 using the planar heating material may be used as a pipe for hot water supply. For example, when the electric heater 400 using the planar heating material is operated, water may be introduced into an inlet port of the electric heater 400 and the heated water may be discharged to an outlet port.

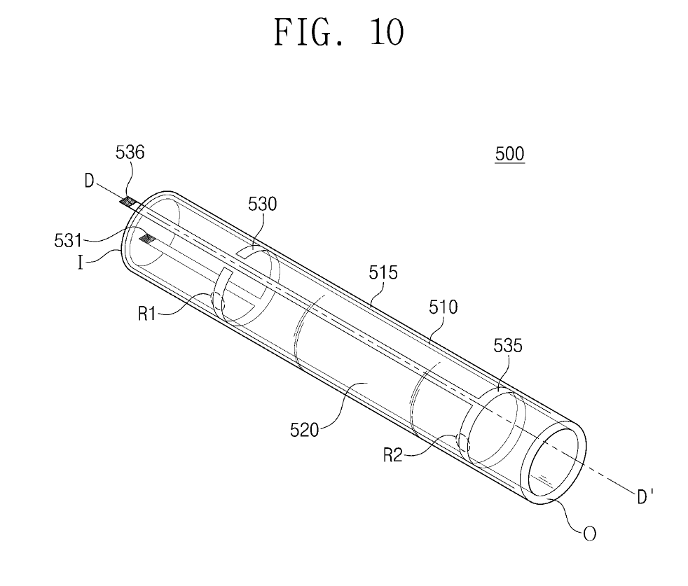

FIG. 10 is a detailed view illustrating a planar heating pipe 500 according to an embodiment of the present invention. The planar heating pipe 500 may include a first pipe 510, a planar heating material 520 coated at an outer surface of the first pipe 510, first and second electrode strips 530 and 535 coated on the planar heating material 520, and a second pipe 515 surrounding the first pipe 510.

The first pipe 510 may include a material having a high thermal conductivity. For example, the first pipe 510 may be formed of glass. However, the material included in the first pipe 510 is not limited thereto, and the first pipe 510 may be made of a plastic having a high thermal conductivity (e.g., a heat-dissipating plastic).

The planar heating material 520 may be coated at the outer surface of the first pipe 510. The planar heating material 520 may not be coated at the entire outer surface of the first pipe 510 and may be coated at a part of the first pipe so that the first and second electrode strips 530 and 535 provided on the first pipe 510 may be electrically connected to each other. These materials included in the planar heating material 520 have been described in detail with reference to FIG. 1, and a repeated description will be omitted.

As shown in FIG. 10, the first electrode strip 530 may include a broken ring (or a discontinuous ring) R1. This is to prevent the first electrode strip 530 and the second electrode strip 535 from electrically short-circuited. In addition, the first electrode strip 530 may include a strip connecting the broken ring R1 to the outside of the planar heating pipe 500. However, according to an embodiment, the first electrode strip 530 may include an unbroken ring or a continuous ring. In this case, an insulating material or the like for preventing the first electrode strip 530 and the second electrode strip 535 from electrically short-circuited may be further provided between the first electrode strip 530 and the second electrode strip 535.

The second electrode strip 535 may include an unbroken ring or a continuous ring R2. The second electrode strip 535 may be formed outside of the first pipe 510 not to be electrically short-circuited with the first electrode strip 530. And the second electrode strip 535 may include a strip connecting the ring R2 to the outside of the planar heating pipe 500. For example, a length of the strip connecting the ring R2 of the second electrode strip 535 to the outside may be longer than a length of the strip connecting the ring R1 of the first electrode strip 530 to the outside.

First and second terminals 531 and 536 may be formed at one ends of the first and second electrode strips 530 and 535, respectively. For example, the first terminal 531 may be connected to a positive electrode, and the second terminal 536 may be connected to a negative electrode.

The second pipe 515 may be similar to the first pipe 510. However, the second pipe 515 may have a diameter larger than a diameter of the first pipe 510 so as to surround the first pipe 510. For example, the second pipe 515 may be made of glass or a plastic having a high thermal conductivity (e.g., a heat dissipating plastic).

On the other hand, water may be introduced through an inlet I of the planar heating pipe 500 and water may be discharged through an outlet O. At this time, in order to prevent leakage of current, water should not flow into an overlapping portion of the first pipe 510 and the second pipe 515 in the outlet O of the planar heating pipe. Accordingly, the first pipe 510 and the second pipe 515 may be connected as one through the heat treatment process of the outlet O of the planar heating pipe. Similarly, an overlapping portion of the first pipe 510 and the second pipe 515 in the inlet I of the planar heating pipe may be connected as one through the heat treatment.

The inner and outer surfaces of the planar heating pipe 500 may be coated with a ceramic material. For example, the ceramic material may include silica (SiO₂), isopropyl alcohol (IPA), distilled water (H₂O), zirconia (ZrO₂), a black inorganic pigment (e.g., CuO₂, CrO₂), a white inorganic pigment (e.g., TiO₂), or mixtures thereof. Since the composition ratios of these materials have been described in detail in FIG. 2, a detailed description thereof will be omitted.

Alternatively, according to an embodiment, the above-described ceramic material may be coated at the inner surface of the planar heating pipe 500 (that is, the inner surface of the first pipe 510) or the outer surface of the planar heating pipe 500 (that is, the outer surface of the second pipe 515). According to another embodiment, the ceramic material may not be coated at the planar heating pipe 500.

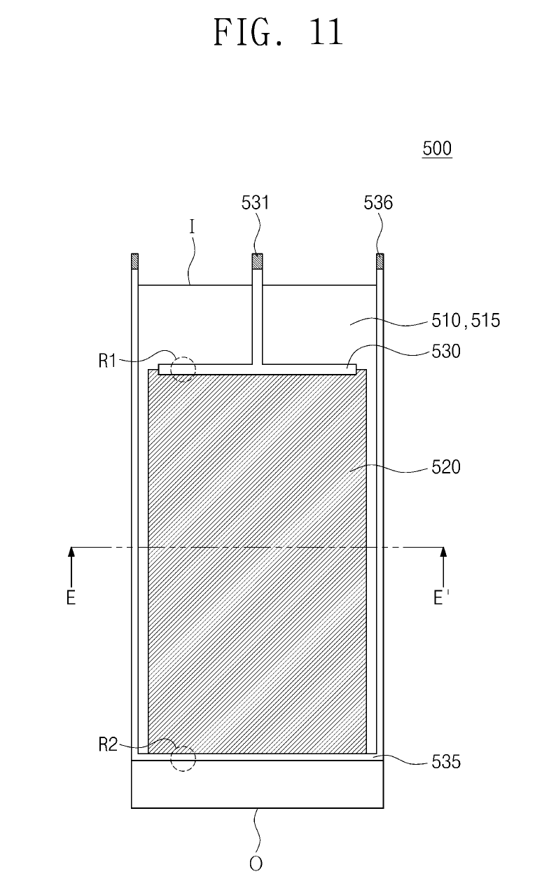

FIG. 11 is a plan view taken along a line D-D′ of the planar heating pipe 500 illustrated in FIG. 10. For the sake of simplicity of the illustration, the planar heating pipe 500 is shown to be flattened after the planar heating pipe 500 is cut along the line D-D′. That is, what is shown in FIG. 11 will actually be the outer surface of the planar heating pipe 500. According to this illustration, the first electrode strip 530 is shown to have a “T” shape. Also, since the second electrode strip 535 is also cut along the line D-D′, the second electrode strip 535 is shown to have an angular U-shape.

Upon operation of the planar heating pipe 500, one current path electrically connecting the first electrode strip 530, the planar heating material 520, and the second electrode strip 535 to one another may be formed. In order to form this current path, the first terminal 531 may be connected to a positive electrode and the second terminal 536 may be connected to a negative electrode.

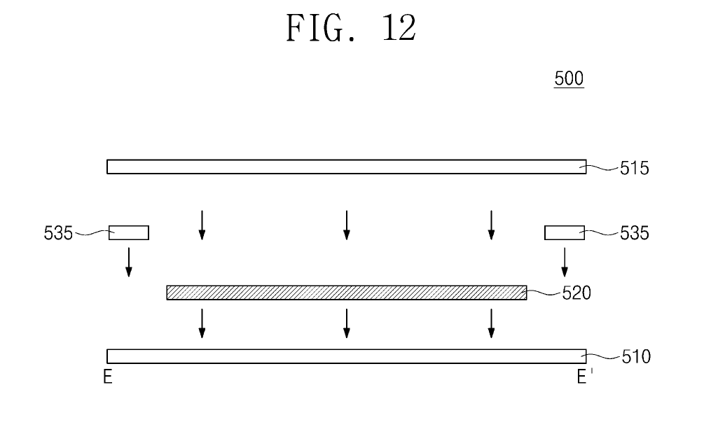

FIG. 12 is a cross-sectional view taken along a line E-E′ of the planar heating pipe 500 illustrated in FIG. 11. To help the understanding of explanation, a description will be made with reference to FIGS. 11 and 12.

The planar heating material 520 may be coated at the outer surface of the first pipe 510. The planar heating pipe 500 is flattened after the planar heating pipe 500 is cut along a cutting direction so that the first pipe 510 is shown as being flat in FIG. 12.

The first electrode strip 530 may be coated on the planar heating material 520 or the insulating material 222. For example, the ring R1 of the first electrode strip 530 may be coated at the inlet of the planar heating material 520. FIG. 12 shows that the ring R1 of the first electrode strip 530 is coated not only to the planar heating material 520 but also to the first pipe 510. However, for electrical connection, it is sufficient that at least a part of the ring R1 of the first electrode strip 530 is in contact with the planar heating material 520.

The second electrode strip 535 may be coated on the outer surface of the first pipe 510 or on the planar heating material 520. For example, the ring R2 of the second electrode strip 535 may be coated at the outlet port of the planar heating material 520. Likewise, for electrical connection, it is sufficient that at least a part of the ring R2 of the second electrode strip 535 is in contact with the planar heating material 520.

Finally, the second pipe 515 may be formed to surround the first pipe 510, the planar heating material 520, and the first and second electrode strips 530 and 535. In addition, when the planar heating pipe 500 is operated, water should not flow into a gap between the first pipe 510 and the second pipe 515. Accordingly, the first pipe 510 and the second pipe 515 may be connected as one through the heat treatment process of the outlet O of the planar heating pipe.

Thermal efficiency of the planar heating pipe 500 may be further improved through the above-described double pipe structure. For example, if water flows through the inside and outside of the planar heating pipe 500, not only the water flowing inside of the planar heating pipe 500 but also the water passing through the outside of the planar heating pipe 500 may be heated.

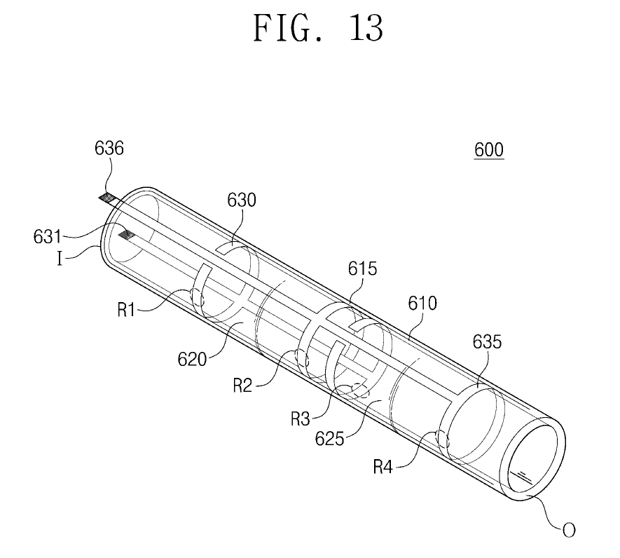

FIG. 13 is a detailed view illustrating another example of a planar heating pipe 600 according to an embodiment of the present invention. The planar heating pipe 600 may include a first pipe 610, a planar heating material 620 coated at an outer surface of the first pipe 610, first and second electrode strips 630 and 635 coated at the outer surface of the first pipe 610, a second pipe 615 surrounding the first pipe 610.

The first pipe 610 may include a material having a high thermal conductivity. For example, the first pipe 610 may be formed of glass. However, the material constituting the first pipe 610 is not limited thereto, and the first pipe 610 may be made of a plastic having a high thermal conductivity (e.g., a heat-dissipating plastic).

The first and second planar heating materials 620 and 625 may be coated at the outside of the first pipe 610. For example, the first and second planar heating materials 620 and 625 may include metal powder, carbon black, carbon powder, graphite powder, or various combinations thereof.

Composition ratios of these materials have been described above with reference to FIG. 1, and a detailed description thereof will be omitted.

In order that a current applied from the outside flows through the first and second planar heating materials 620 and 625, the first and second electrode strips 630 and 635 may be provided to both ends of the first and second planar heating materials 620 and 625. For example, the first and second electrode strips 630 and 635 may be formed of a silver paste.

The first electrode strip 630 may include two rings R1 and R3. For example, the ring R1 may be a broken ring (or a discontinuous ring). This is to prevent the ring R1 of the first electrode strip 630 and the second electrode strip 635 from being electrically short-circuited. The ring R3 may be an unbroken ring (or a continuous ring). In this case, an insulating material may be further provided to prevent the ring R3 of the first electrode strip 630 and the second electrode strip 635 from being short-circuited. For example, the insulating material may be provided at a portion where the ring R3 of the first electrode strip 630 and the second electrode strip 635 are overlapped.

The second electrode strip 635 may include two rings R2, R4. For example, the rings R2 and R4 may be unbroken rings or continuous rings. However, when the ring R2 is not broken, an insulating material may be further provided to prevent the first electrode strip 630 and the second electrode strip 635 from being electrically short-circuited. For example, the insulating material may be provided at a portion where the first electrode strip 630 and the ring R2 are overlapped. Alternatively, according to an embodiment, the ring R2 may be a broken ring (or a discontinuous ring). In this case, since the first electrode strip 630 and the second electrode strip 635 are properly arranged not to be electrically short-circuited, the additional insulating material may not be required.

The first electrode strip 630 may include a strip connecting the rings R1 and R3 to the outside of the planar heating pipe 600. The second electrode strip 635 may include a strip connecting the rings R2 and R4 to the outside of the planar heating pipe 600. For example, a length of the strip connecting the rings R2 and R4 to the outside of the planar heating pipe 600 may be longer than a length of the strip connecting the rings R1 and R3 to the outside of the planar heating pipe 600.

First and second terminals 631 and 636 may be formed at one ends of the first and second electrode strips 630 and 635, respectively. For example, the first terminal 631 may be coupled to a positive electrode and the second terminal 636 may be coupled to a negative electrode.

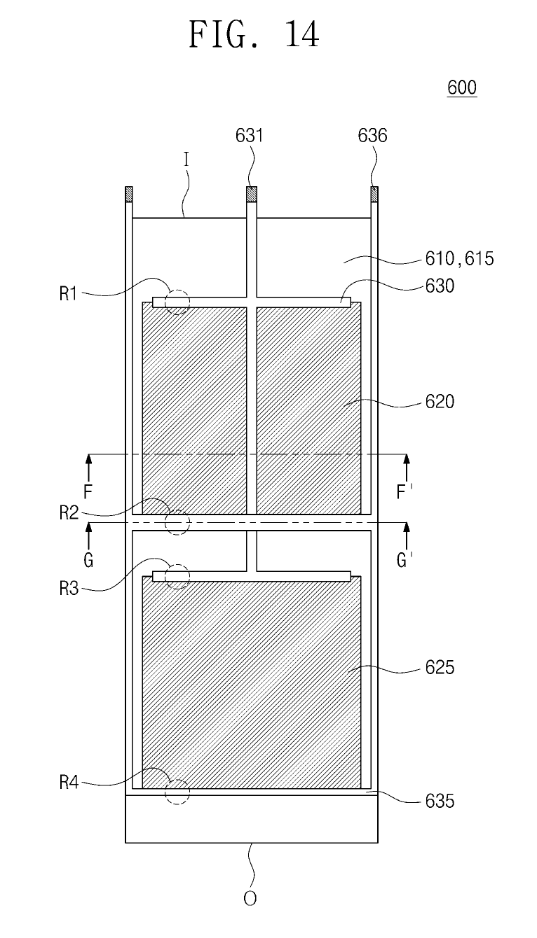

FIG. 14 is a plan view of the planar heating pipe 600 illustrated in FIG. 13. For the sake of simplicity of the illustration, the line D-D′ shown in FIG. 10 has not been shown. However, FIG. 14 shows a flattened side after being cut in a manner similar to that shown in FIG. 10. That is, what is shown in FIG. 14 may be an outer surface of the planar heating pipe 600.

When the planar heating pipe 600 is operated, one path electrically connecting the ring R1 of the first electrode strip 630, the first planar heating material 620, and the ring R2 of the second electrode strip 635 to one another may be formed. At the same time, another path electrically connecting the ring R3 of the first electrode strip 630, the second planar heating material 625, and the ring R4 of the second electrode strip 635 to one another may be formed. In order to form the current paths, the first terminal 631 may be connected to a positive electrode and the second terminal 636 may be connected to a negative electrode.

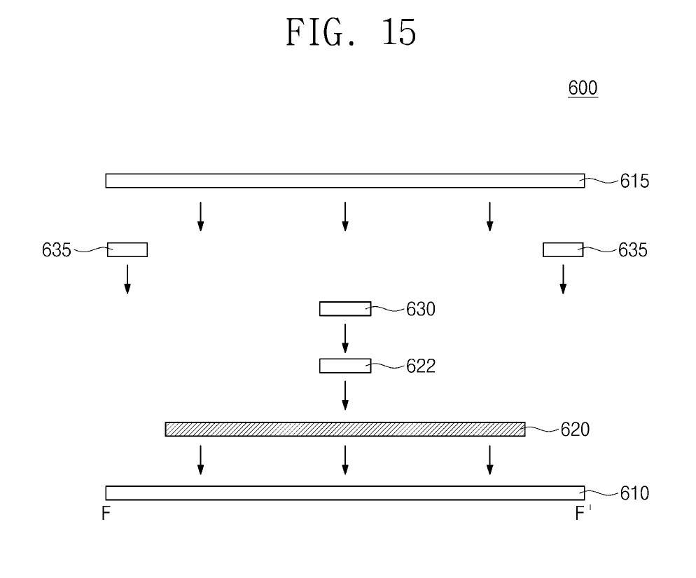

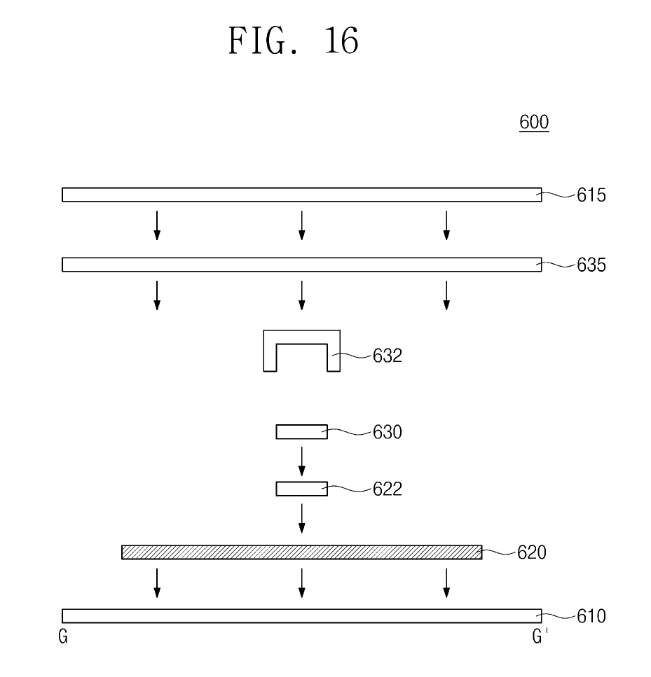

FIG. 15 is a cross-sectional view taken along a line F-F′ of the planar heating pipe 600 illustrated in FIG. 14. FIG. 16 is a cross-sectional view taken along a line G-G′ of the planar heating pipe 600 illustrated in FIG. 14. To help understanding of the explanation, a description will be made with reference to FIG. 15 and FIG. 16 together with FIG. 14.

The first planar heating material 620 may be coated at the outside of the first pipe 610. After the first pipe 610 is cut along the line F-F′ or the line G-G′, the first pipe 610 is flatten so that the first pipe 610 is illustrated as being flat in the figures.

An insulating material 222 may be coated on the first planar heating material 620. This is to electrically isolate the first planar heating material 620 from a strip except for the rings R1 and R2 of the first electrode strip 630. The ring R1 of the first electrode strip 630 may be directly coated on the first planar heating material 620. Alternatively, according to an embodiment, the insulating material 222 may not be provided. In this case, both the ring R1 of the first electrode strip 630 and the strip may be directly coated on the first planar heating material 620.

The first electrode strip 630 may be coated on the first planar heating material 620 or the insulating material 222. For example, the ring R1 of the first electrode strip 630 may be directly coated on the first planar heating material 620. The ring R3 of the first electrode strip 630 may be directly coated on the second planar heating material 625. In addition, a strip other than the rings R1 and R3 of the first electrode strip 630 may be coated at the first planar heating material 620, the insulating material 222, or the outside of the first pipe 610.

The second electrode strip 635 may be coated at the outside of the first pipe 610. For example, the ring R2 of the second electrode strip 635 may be coated on the first planar heating material 620 or the insulating material 222. The ring R4 of the second electrode strip 635 may be directly coated on the second planar heating material 625.

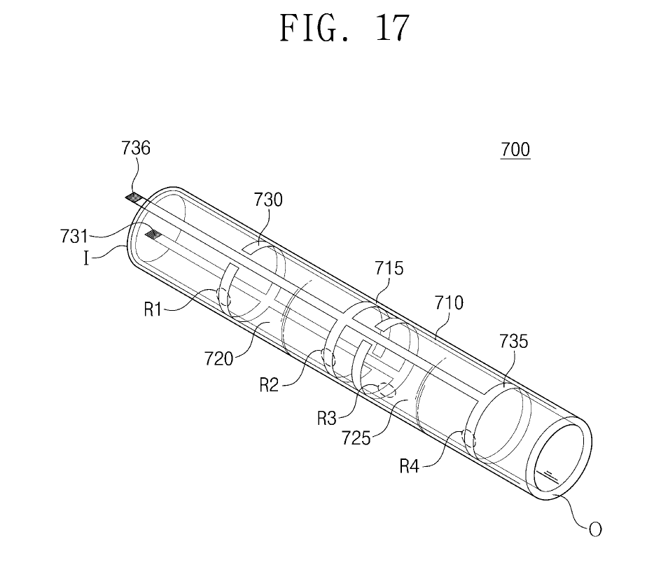

However, when this coating method is carried out, in a plan viewpoint, the first electrode strip 630 and the second electrode strip 635 should not be electrically short-circuited at a portion where the first electrode strip 630 and the second electrode strip 635 are overlapped. To this end, as shown in FIG. 17, an insulating material 132b may be additionally provided on the first electrode strip 630.

Finally, a second pipe 615 may be provided on the first pipe 610. When the planar heating pipe 600 is operated, water should not flow into a gap between the first pipe 610 and the second pipe 615. Accordingly, the first pipe 610 and the second pipe 615 may be connected as one through a heat treatment process of an outlet O of the planar heating pipe 600. Similarly, the first pipe 610 and the second pipe 615 may be connected as one through a heat treatment process of an inlet I of the planar heating pipe 600.

FIG. 17 is a detailed view illustrating another example of a planar heating pipe 700 according to an embodiment of the present invention. The planar heating pipe 700 may include a first pipe 710, a planar heating material 720 coated at an outer surface of the first pipe 710, first and second electrode strips 730 and 735 coated at the outer surface of the first pipe 710, and a second pipe 715 surrounding the first pipe 710.

This embodiment is substantially the same as the embodiment of FIG. 13 except that the ring R2 of the first electrode strip 730 is a broken ring (or a discontinuous ring). Therefore, a repeated description will be omitted. Since the ring R2 of the first electrode strip 730 and the ring R3 of the second electrode strip 735 are broken rings so that the electrode strips 730 and 735 may be properly formed not to contact each other, thereby preventing an electrical short circuit therebetween. In addition, an additional insulating material may not be required to insulate the electrode strips 730 and 735 from one another.

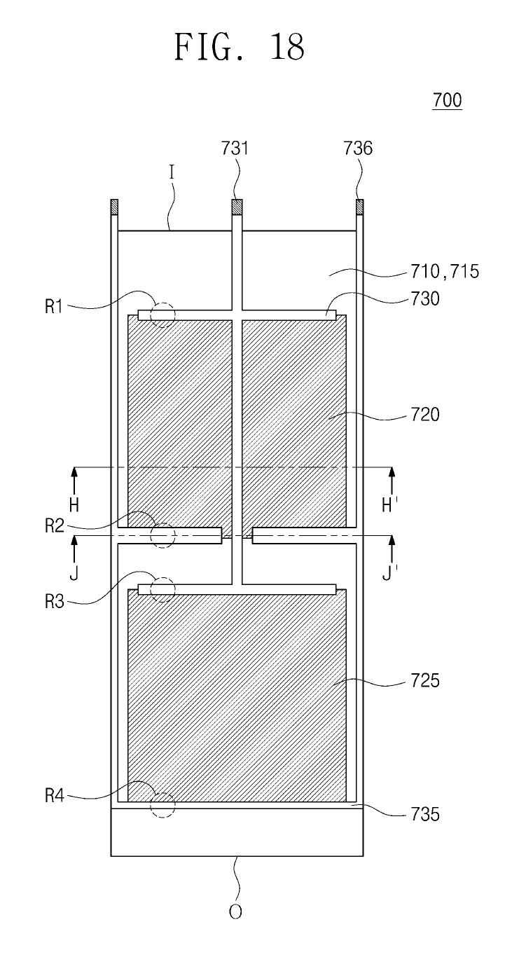

FIG. 18 is a plan view of the planar heating pipe 700 illustrated in FIG. 17. For the sake of simplicity of the illustration, the line D-D′ shown in FIG. 10 has not been shown. However, FIG. 18 shows a flattened side after being cut in a manner similar to that shown in FIG. 10. That is, what is shown in FIG. 18 may be an outer surface of the planar heating pipe 700.

When the planar heating pipe 700 is operated, one path electrically connected the ring R1 of the first electrode strip 730, the first planar heating material 720, and the ring R2 of the second electrode strip 635 to one another may be formed. At the same time, another path electrically connecting the ring R3 of the first electrode strip 730, the second planar heating material 725, and the ring R4 of the second electrode strip 635 to one another may be formed. In order to form the current paths, a first terminal 731 may be connected to a positive electrode and a second terminal 736 may be connected to a negative electrode.

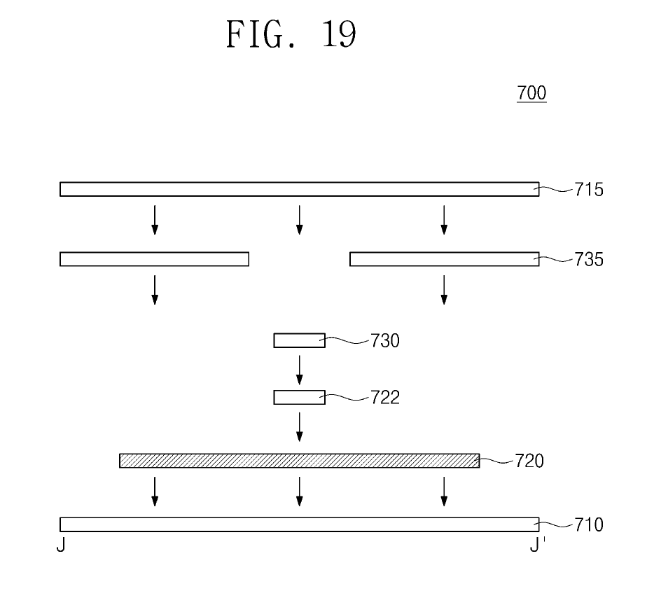

FIG. 19 is a cross-sectional view taken along a line J-J′ of the planar heating pipe 700 illustrated in FIG. 18. The sectional view taken along a line H-H′ is substantially the same as that of FIG. 15, and a detailed description thereof will be omitted. To help understanding of explanation, a description will be made with reference to FIG. 19 together with FIG. 18.

The first planar heating material 720 may be coated at the outside of the first pipe 710. After the first pipe 710 is cut along the line J-J′, the first pipe 710 is flattened so that the first pipe 710 is shown as being flat in the figure.

An insulating material 722 may be coated on the first planar heating material 720. This is to electrically isolate the first planar heating material 720 from a strip except for the rings R1 and R2 of the first electrode strip 730. The ring R1 of the first electrode strip 730 may be directly coated on the first planar heating material 720. Alternatively, according to an embodiment, the insulating material may not be provided. In this case, both the ring R1 of the first electrode strip 730 and the strip will be directly coated on the first planar heating material 720.

The first electrode strip 730 may be coated on the first planar heating material 720 or the insulating material 722. For example, the ring R1 of the first electrode strip 730 may be directly coated on the first planar heating material 720. The ring R3 of the first electrode strip 730 may be directly coated on the second planar heating material 725. In addition, a strip other than the rings R1 and R3 of the first electrode strip 730 may be coated at the first planar heating material 720, the insulating material 722, or the outside of the first pipe 710.

The second electrode strip 735 may be coated at the outside of the first pipe 710. For example, the ring R2 of the second electrode strip 735 may be coated on the first planar heating material 720. The ring R4 of the second electrode strip 735 may be directly coated on the second planar heating material 725.

In this embodiment, it has been described that the second electrode strip 735 is coated at the outside of the first pipe 710 after the first electrode strip 730 is coated. However, in a plan viewpoint illustrated in FIG. 18, the first electrode strip 730 and the second electrode strip 735 may be simultaneously may be coated at the outside of the pipe 710 since the first electrode strip 730 and the second electrode strip 735 are not overlapped.

Finally, a second pipe 715 may be provided on the first pipe 710. For example, the second pipe 715 may be formed to surround the first pipe 710, the first electrode strip 730, and the second electrode strip 735. When the planar heating pipe 700 is operated, water should not flow into a gap between the first pipe 710 and the second pipe 715. Accordingly, the first pipe 710 and the second pipe 715 may be connected as one through a heat treatment process of an outlet O of the planar heating pipe 700. Similarly, the first pipe 710 and the second pipe 715 may be connected as one through a heat treatment process of an inlet I of the planar heating pipe 700.

The planar heating pipes according to the embodiment of the present invention have been described with reference to FIGS. 10 to 19. According to the embodiments, it is possible to achieve the same effect as implementing two planar heating elements in one planar heating pipe. Forming the first and second electrode strips through the coating method prevents an electrical short circuit, and the manufacturing thereof is easy. In addition, if water is allowed to flow through the inside and outside of the planar heating pipe, not only the water flowing through the inside of the planar heating pipe but also the water flowing through the outside of the planar heating pipe may be heated to improve the thermal efficiency of the planar heating pipe.

FIG. 20 is a view illustrating a water heater 1000 using a planar heating element according to an embodiment of the present invention. Referring to FIG. 20, a water heater 1000 using a planar heating element may include a planar heating pipe 1100, a hot water tank 1200, a first header 1300, and a second header 1400. For the sake of clarification of illustration, FIG. 20 shows an inside view of the water heater 1000 using the planar heating element cut along a line K-K′ formed on an upper surface of the water heater 1000 using the planar heating element and a line L-L′ formed on a lower surface of the water heater 1000 using the planar heating element.

An operation of the water heater 1000 using the planar heating element according to the embodiment of the present invention will be briefly described below. Water introduced into an inlet of the water heater 1100 using the planar heating element may be heated while passing through the inside and outside of the planar heating pipe 1100. Then, the hot water heated by the planar heating pipe 1100 may be discharged to the outside through a water outlet provided at the hot water tank 1200.

For this operation, the planar heating pipe 1100 may have a pipe type in which both ends are opened. For example, the planar heating pipe 1100 may be any one of the planar heating pipes described in FIGS. 10 to 19. Water may be introduced from the outside through one end of the planar heating pipe 1100 and the other end of the planar heating pipe 1100 may be coupled with the hot water tank 1200.

The hot water tank 1200 may have a pipe shape. For example, a diameter of the hot water tank 1200 may be larger than a diameter of the planar heating pipe 1100. One end of the hot water tank 1200 (that is, the lower portion of the hot water tank in the drawing) may be completely opened similar to both ends of the planar heating pipe 1100. However, the other end of the hot water tank 1200 (that is, the upper surface of the hot water tank in the drawing) may be partially blocked. That is, the hot water tank 1200 may be defined as including an upper surface having a relatively large hole and a plurality of small holes. In addition, the hot water tank 1200 may be defined as including a completely open lower surface. The planar heating pipe 1100 may be coupled with the large hole of the upper surface of the hot water tank 1200.

The first header 1300 may be provided on the upper surface of the hot water tank 1200. For example, the inner surface of the first header 1300 and the upper surface of the hot water tank 1200 may be attached to each other to form a space between the inner surface of the first header 1300 and the upper surface of the hot water tank 1200. The space will be referred to as a first housing in this specification. In other words, the first housing may be a space defined by the upper surface of the hot water tank 1200 and the inner surface of the first header 1300. The first housing formed by coupling the hot water tank 1200 with the first header 1300 may be a space where the water introduced through the inside of the planar heating pipe 1100 temporarily remains.

The second header 1400 may be attached to the open lower surface of the hot water tank 1200. For example, the second header 1400 may be attached one end of the planar heating pipe 1100 and the open lower surface of the hot water tank 1200 to form a space between the outer surface of the planar heating pipe 1100 and the inner surface of the hot water tank 1200. The space will be referred to as a second housing in this specification. In other words, the second housing may be a space defined by the outer surface (or a side surface) of the planar heating pipe 1100, the inner surface of the hot water tank 1200, and the inner surface of the second header 1400. The second housing 1400 formed by the engagement of the second header 1400, the planar heating pipe 1100, and the hot water tank 1200 may be a space where the water introduced from the first housing temporarily remains before being discharged to the outlet.

When the hot water tank 1000 using the planar heating element according to the embodiment of the present invention is operated, flow of water will be briefly described below. Water introduced through the inlet is transferred to the first housing through the planar heating pipe 1100. The water filled in the first housing is transferred to the second housing through a plurality of small holes formed in the upper surface of the hot water tank 1200. Finally, the water filled in the second housing is discharged to the outside through the outlet. That is, the water introduced from the outside flows through the inside of the planar heating pipe 1100 and simultaneously flows through the outside of the planar heating pipe 1100. In this process, the water may be heated by the heat generated from the planar heating pipe 1100. The efficiency of the water heater may be improved by the above-described double heating mechanism.

The hot water tank 1200, the first header 1300, and the second header 1400 may include a metal material. However, the present invention is not limited thereto, and the hot water tank 1200, the first header 1300, and the second header 1400 may be made of a plastic. In the embodiment, the planar heating pipe 1100, the hot water tank 1200, the first header 1300, and the second header 1400 are shown in a cylindrical shape, but are not limited thereto. The planar heating pipe 1100, the hot water tank 1200, the first header 1300, and the second header 1400 may take various shapes such as a hexahedron, a square pillar, and the like. The shape of the small holes as well as the large hole coupled with the planar heating pipe 1100, which are formed on the upper surface of the hot water tank 1200, is not limited to a circular shape.

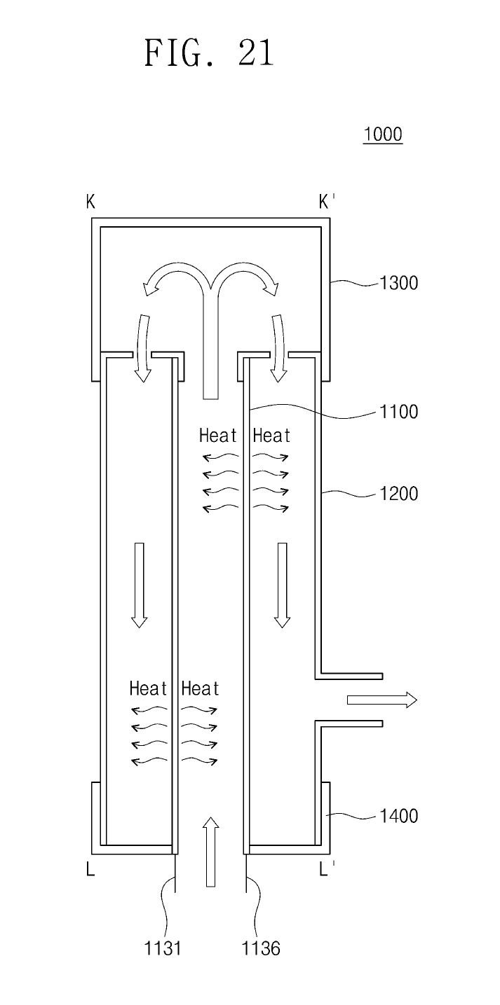

FIG. 21 is a view illustrating a schematic operation of the water heater 1000 using the planar heating element according to an embodiment of the present invention. More specifically, FIG. 21 is a cross-sectional view along a line K-K′ and a line L-L′ shown in FIG. 20. Thick arrows illustrated in FIG. 21 schematically show flow of water, and small arrows show heat emitted from the planar heating pipe 1100.

The water heater 1000 using the planar heating element may include a planar heating pipe 1100, a hot water tank 1200, a first header 1300, and a second header 1400. Water is introduced from the outside through one end of the planar heating pipe 1100. The other end of the planar heating pipe 1100 is coupled with a large hole formed on the upper surface of the hot water tank 1200. The first header 1300 may be coupled with the upper surface of the hot water tank 1200. As a result, a first housing, which is a space defined by the first header 1300 and the upper surface of the hot water tank 1200, may be formed. The second header 1400 may be coupled with the lower surface of the hot water tank 1200. As a result, a second housing, which is a space defined by the outer surface of the planar heating pipe 1100, the inner surface of the hot water tank 1200, and the second header 1400, may be formed.

When the water heater 1000 using the planar heating element is operated, electricity is supplied through two electrodes 1131 and 1136 of the planar heating pipe 1100. The water introduced into one end of the planar heating pipe 1100 may be heated primarily while passing through the inside of the planar heating pipe 1100. The primarily heated water may be stored in the first housing and the water stored in the first housing may be transferred to the second housing through the small holes formed in the upper surface of the hot water tank 1200. The water transferred to the second housing may be secondarily heated by the planar heating pipe 1100. Finally, the secondarily heated water may be discharged to the outside through an outlet provided in the hot water tank 1200.

Although not shown in detail in the drawings, the water heater 1000 using the planar heating element according to the embodiment of the present invention may further include a configuration for coupling the hot water tank 1200 with the first header 1300 and a configuration for coupling the hot water tank 1200 with the second header 1400. As an example of the coupling structures, there may be a screw, a rubber packet, etc., but these are merely illustrative. In other words, various configurations may be used for tightly coupling the planar heating pipe 1100, the hot water tank 1200, the first header 1300, and the second header 1400 with one another to form the first and second housings.

The water heater 1000 using the planar heating element according to the embodiment of the present invention has been described above. According to the present invention, the elements constituting the water heater 1000 using the planar heating element (i.e., the planar heating pipe, the hot water tank, the first header, and the second header) may be manufactured in a modular manner. Therefore, there is an advantage that repair and replacement of parts are easy. In addition, since the water flowing through the inside of the planar heating pipe 1100 and the water flowing through the outside of the planar heating pipe 1100 may be heated at the same time, the heat efficiency of the water heater using the planar heating element may be improved.

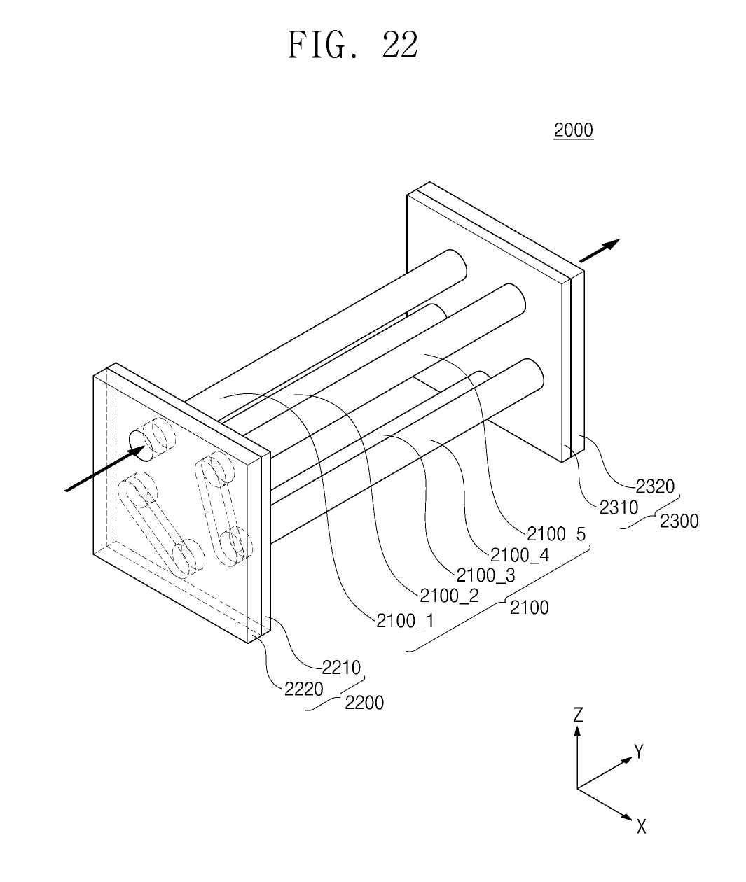

FIG. 22 is a view illustrating a heat exchanger using a planar heating element according to an embodiment of the present invention. Referring to FIG. 22, the heat exchanger 2000 using the planar heating element may include a plurality of heat transfer pipes 2100, a first connection part 2200, and a second connection part 2300.

The plurality of heat transfer pipes 2100 may include a first heat transfer pipe 2100_1 to a fifth heat transfer pipe 2100_5. For example, the first to fifth heat transfer pipes 2100_1 to 2100_5 may be substantially the same. For example, the first heat transfer pipe 2100_1 to the fifth heat transfer pipe 2100_5 may be any one of the planar heating pipes described above with reference to FIGS. 10 to 19. Illustratively, the plurality of heat transfer pipes 2100 are shown as being composed of five heat transfer pipes. However, this is for exemplary purposes only, and the present invention is not limited thereto.

Each of the plurality of heat transfer pipes 2100 may include a planar heating material. For example, the planar heating material may be coated at an outside of each of the heat transfer pipes 2100, and a plurality of heat transfer pipes 2100 may generate heat using electricity applied to the planar heating material.

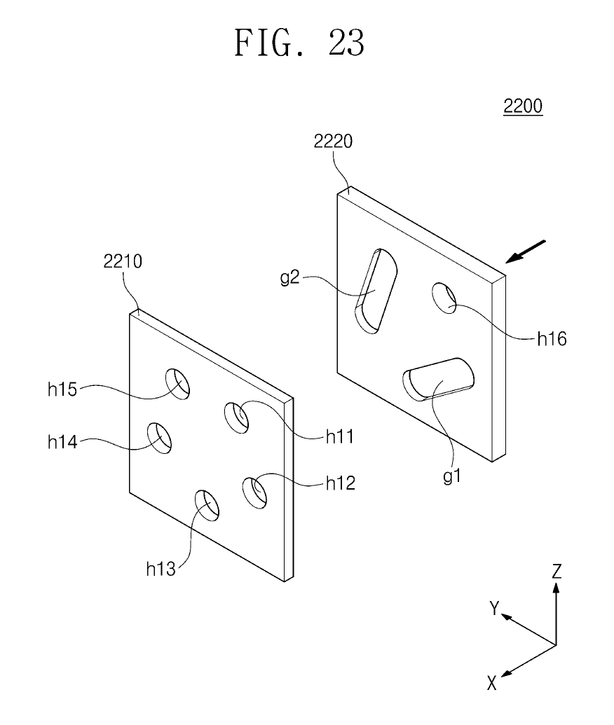

The first connection part 2200 may include a first connection plate 2210 and a second connection plate 2220. Holes may be formed in the first connection plate 2210 as many as the number of the heat transfer pipes 2100. For example, the holes may be formed to penetrate the first connecting plate 2210. One ends of the plurality of heat transfer pipes may be coupled with the plurality of holes formed in the first connection plate 2210, respectively. At least one hole may be formed in the second connection plate 2220 to allow water flowing from the outside to flow through the heat transfer pipe. A groove may be formed at the second connection plate 2220 and may be connected to two adjacent heat transfer pipes (e.g., the second heat transfer pipe 2100_2 and the third heat transfer pipe 2100_3, or the fourth heat transfer pipe 2100_4 and the fifth heat transfer pipe 2100_5) so that water flows. For example, the groove may be formed not to penetrate the second connection plate 2220. The detailed structures of the first connection plate 2210 and the second connection plate 2220 will be described in more detail with reference to FIG. 23.

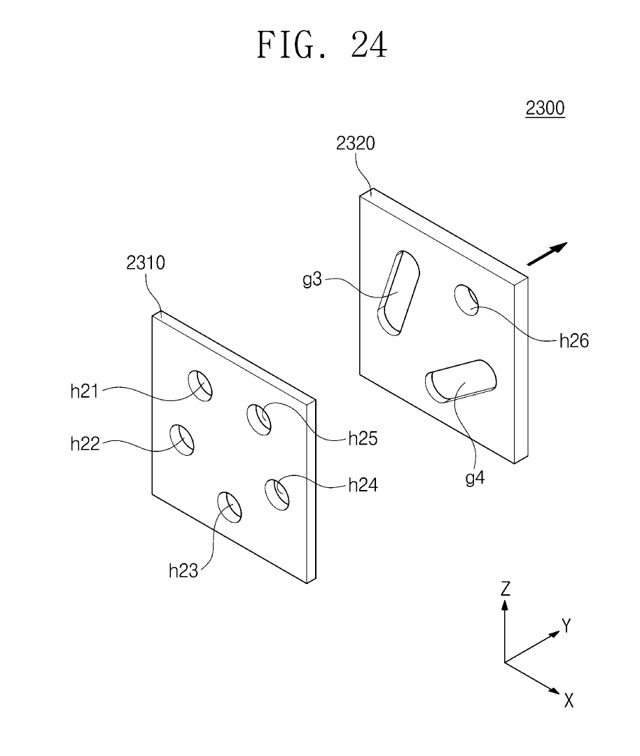

The second connection part 2300 may include a third connection plate 2310 and a fourth connection plate 2320. Holes may be formed in the third connection plate 2310 as many as the number of heat transfer pipes 2100. For example, the holes may be formed to penetrate the third connection plate 2310. The other ends of the plurality of heat transfer pipes may be coupled with the plurality of holes formed in the third connection plate 2310, respectively. At least one hole for allowing water flowing from the outside to flow through the heat transfer pipe may be formed at the fourth connection plate 2320. A groove may be formed at the fourth connection plate 2320 and may be connected to two adjacent heat transfer pipes (e.g., the first heat transfer pipe 2100_1 and second heat transfer pipe 2100_2, or the third heat transfer pipe 2100_3 and the fourth heat transfer pipes 2100_4) so that water flows. For example, the groove may be formed not to penetrate the fourth connection plate 2320. The detailed structures of the third connection plate 2310 and the fourth connection plate 2320 will be described in more detail with reference to FIG. 24.

A schematic operation of the heat exchanger 2000 using the planar heating element according to the embodiment of the present invention will be described as follows. For example, water flows into the first heat transfer pipe 2100_1 through the holes formed in the second connection plate 2220 and the first connection plate 2210. At this time, the water may be heated by heat of the first heat transfer pipe 2100_1. The water flows into the second heat transfer pipe 2100_2 through the holes formed in the third connection plate 2310 and the groove formed in the fourth connection plate 2320. At this time, the water may be heated by heat of the second heat transfer pipe 2100_2. The water flows into the third heat transfer pipe 2100_3 through the holes formed in the first connection plate 2210 and the groove formed in the second connection plate 2220. At this time, the water may be heated by the heat of the third heat transfer pipe 2100_3. The above-described series of operations occurs continuously to the fifth heat transfer pipe 2100_5. In other words, finally, the water heated by the heat of the fifth heat transfer pipe 2100_5 is discharged to the outside through the holes formed in the third connection plate 2310 and the holes formed in the fourth connection plate 2320.

FIG. 23 is a detailed view illustrating a first connection part 2200 illustrated in FIG. 22. The first connection part 2200 may include the first connection plate 2210 and the second connection plate 2220. Although not shown in the drawing, a gasket (not shown) or the like may be further provided between the first connection plate 2210 and the second connection plate 2220 to prevent water from leaking. An arrow illustrated in FIG. 23 conceptually shows the inflow of water.

The first connection plate 2210 may have a first hole h11 to a fifth hole h15. For example, first to fifth holes h11 to h15 may be formed to penetrate the first connection plate 2210. The first to fifth holes h11 to h15 may be formed to have a suitable size to couple the first heat transfer pipe (see FIG. 22, 2100_1) to the fifth heat transfer pipe (see FIGS. 22 and 2100_5) with the first to fifth holes h11 to h15, respectively. For example, the number of holes formed in the first connection plate 2210 may be the same as the number of heat transfer pipes (see FIG. 22, 2100). For example, the first connection plate 2210 may include a metallic material. However, the present invention is not limited thereto, and the first connection plate 2210 may be made of a reinforced plastic or the like.

The second connection plate 2220 may include a sixth hole h16, a first groove g1, and a second groove g2. The sixth hole h16 may be formed to penetrate the second connection plate 2220. For example, the sixth hole h16 may correspond to the first hole h11. That is, the sixth hole h16 may be formed to have an appropriate size to one end of the first heat transfer pipe (see FIG. 22, 2100_1) with the sixth hole h16. The first groove g1 and the second groove g2 may be formed not to penetrate the second connection plate 2220. For example, the first groove g1 may correspond to the second and third holes h12 and h13. For example, the second groove g2 may correspond to the fourth and fifth holes h14 and h15.

As the first connection plate 2210 and the second connection plate 2220 are coupled with each other, the water introduced into the second hole h12 passes through the first groove g1 to be discharged through the third hole h13. As the first connection plate 2210 and the second connection plate 2220 are coupled with each other, the water introduced into the fourth hole h14 passes through the second groove g2 to be discharged through the fifth hole h15.

FIG. 24 is a detailed view illustrating a second connection part 2300 illustrated in FIG. 22. The second connection part 2300 may include the third connection plate 2310 and the fourth connection plate 2320. Although not shown in the drawing, a gasket (not shown) or the like may be further provided between the third connection plate 2310 and the fourth connection plate 2320 to prevent water from leaking. An arrow shown in FIG. 24 conceptually shows that water is discharged.

The third connection plate 2310 may have a first hole h21 to a fifth hole h25. For example, the first to fifth holes h21 to h25 may be formed to penetrate the second connection plate 2310. The first to fifth holes h21 to h25 may be formed to have an appropriate size to couple the first heat transfer pipe (see FIG. 22, 2100_1) to the fifth heat transfer pipe (see FIGS. 22 and 2100_5) with the first to fifth holes h21 to h25, respectively. For example, the number of holes formed in the third connection plate 2310 may be the same as the number of heat transfer pipes (see FIG. 22, 2100). For example, the third connection plate 2310 may include a metal material. However, the present invention is not limited thereto, and the third connection plate 2310 may be made of a reinforced plastic or the like.

The fourth connection plate 2320 may include a sixth hole h26, a third groove g3 and a fourth groove g4. The sixth hole (h26) may be formed to penetrate the fourth connection plate (2320). For example, the sixth hole h26 may correspond to the fifth hole h25. That is, the sixth hole h26 may be formed to have an appropriate size to couple the other end of the first heat transfer pipe (see FIG. 22, 2100_1) with the sixth hole h26. The third groove g3 and the fourth groove g4 may be formed not to penetrate the fourth connection plate 2320. For example, the third groove g3 may correspond to the first and second holes h21 and h22. For example, the fourth groove g4 may correspond to the third and fourth holes h23 and h24.

As the third connection plate 2310 and the fourth connection plate 2320 are coupled with each other, water introduced through the first hole h21 passes through the third groove g3 to be discharged through the second hole h22. As the third connection plate 2310 and the fourth connection plate 2320 are coupled with each other, the water flowing through the third hole h23 passes through the fourth groove g4 to be discharged through the fourth hole h24.

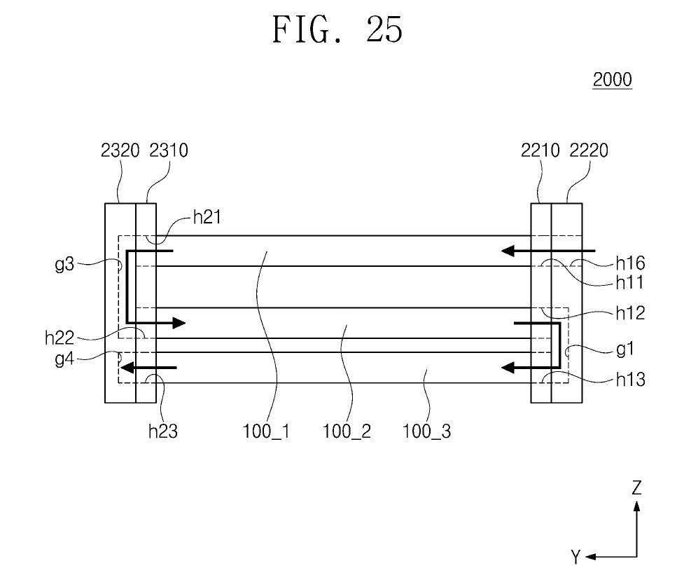

FIG. 25 is a view illustrating one side of the heat exchanger 2000 using the planar heating element illustrated in FIG. 22. Illustratively, FIG. 25 shows the heat exchanger 2000 using the planar heating element viewed along an X-axis direction. To help the understanding of explanation, a water path formed by the holes and grooves formed in the first through fourth connection plates 2210, 2220, 2310, and 2320 is shown.

First, the water introduced through the holes h16 and h11 formed in the second connection plate 2220 and the first connection plate 2210 flows in the first heat transfer pipe 2100_1. Upon operation of the first heat transfer pipe 2100_1, water flowing in the first heat transfer pipe 2100_1 may be heated by heat generated from the planar heating material coated at the outside of the first heat transfer pipe 2100_1.

The water flows in the second heat transfer pipe 2100_2 through the holes h21 formed in the third connection plate 2310, the groove g3 formed in the fourth connection plate 2320, and the hole h22 formed in the third connection plate 2310. Upon operation of the second heat transfer pipe 2100_2, water flowing in the second heat transfer pipe 2100_2 may be heated by the heat of the planar heating material coated at the outside of the second heat transfer pipe 2100_2.

The water flows in the third transfer pipe 2100_3 through the holes h12 formed in the first connection plate 2210, the groove g1 formed in the second connection plate 2220, and the holes h13 formed in the first connection plate 2210, 2100_3. Upon operation of the third heat transfer pipe 2100_3, water flowing in the third heat transfer pipe 2100_3 may be heated by heat of the planar heating material coated at the outside of the third heat transfer pipe 2100_3.

The water may be transferred to the groove g4 formed in the fourth connection plate 2320 through the hole h23 formed in the third connection plate 2210. The water transferred to the groove g4 is ready to be transferred to the fourth heat transfer pipe (see FIG. 22, 2100_4). The subsequent water flow will be described with reference to FIG. 25.

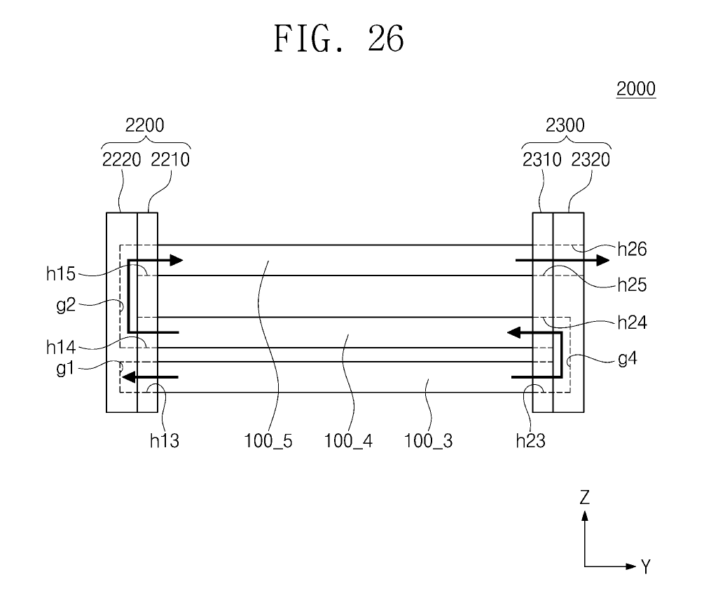

FIG. 26 is a view illustrating one side of the heat exchanger 2000 using the planar heating element illustrated in FIG. 22. Illustratively, FIG. 26 shows the heat exchanger 2000 using the planar heating element which viewed along the X-axis direction is shown. To help the understanding of explanation, a water path formed by the holes and grooves formed in the first through fourth connection plates 2210, 2220, 2310, and 2320 is shown.

The water transferred to the groove g1 formed in the second connection plate 2220 flows in the third heat transfer pipe 2100_3 through the hole h13 formed in the first connection plate 2210. Upon the operation of the third heat transfer pipe 2100_3, water flowing in the third heat transfer pipe 2100_3 may be heated by heat of the planar heating material coated at the outside of the third heat transfer pipe 2100_3.

The water flows in the fourth transfer pipe 2100_4 through the holes h23 formed in the third connection plate 2310, the groove g4 formed in the fourth connection plate 2320, and the hole h24 formed in the third connection plate 2310, 2100_4. Upon the operation of the fourth heat transfer pipe 2100_4, water flowing in the fourth heat transfer pipe 2100_4 may be heated by heat of the planar heating material coated at the outside of the fourth heat transfer pipe 2100_4.

The water flows in the fifth heat transfer pipe 2100_5 through the hole h14 formed in the first connection plate 2210, the groove g2 formed in the second connection plate 2220, and the hole h15 formed in the first connection plate 2210, 2100_5). Upon the operation of the fifth heat transfer pipe 2100_5, the water flowing in the fifth heat transfer pipe 2100_5 may be heated by heat of the planar heating material coated at the outside of the fifth heat transfer pipe 2100_5.

The heated water through the first to fifth heat transfer pipes 2100_1 to 2100_5 may be discharged to the outside through the holes h25 and h26, which are formed in the third connection plate 2310 and the fourth connection plate 2320, respectively.

In the above-described embodiment, the number of heat transfer pipes is shown to be five but the present invention is not limited thereto. That is, the heat exchanger using the planar heating element according to the embodiment of the present invention may include a larger number of heat transfer pipes. Since the heat exchanger 2000 using the planar heating element according to the embodiment of the present invention has been described as including an odd number of heat transfer pipes (i.e., five), the inlet and outlet are provided at different connection parts, respectively. That is, the inlet is provided at the first connection part (see FIG. 22, 2200) and the outlet is provided at the second connection part (see FIG. 22, 2300). However, when the heat exchanger using the planar heating element includes an even number of heat transfer pipes (i.e., planar heating pipes), the inlet and outlet may be provided at the same connection part. For example, when the inlet is formed in the first connecting portion (see FIG. 22, 2200), the outlet may also be formed in the first connecting portion (see FIG. 22, 2200). Conversely, when the inlet is formed in the second connecting portion (see FIG. 22, 2300), the outlet may also be formed in the second connecting portion (see FIG. 22, 2300).

As described above, as the flow path is formed in a zigzag manner by engagement of the heat transfer pipes, the first connection part, and the second connection part, the heat transfer efficiency of the heat exchanger using the planar heating element may be improved. In addition, there is an advantage that volume of the heat exchanger may be reduced.

The above description is a concrete example for carrying out the present invention. The present invention includes not only the above-described embodiments, but also embodiments that may be simply modified or easily changed. In addition, the present invention may include techniques that are easily modified by using the above-described embodiments.

### INDUSTRIAL APPLICABILITY

The present invention is applicable to a pipe using a planar heating material, a water heater using the planar heating material, and a heat exchanger using a pipe using a planar heating material.

What is claimed is:

1. A water heater using a planar heating element comprising:
a planar heating pipe coated with a planar heating material;
a hot water tank including an upper surface coupled with the planar heating pipe where a first hole and a second hole are formed, a side surface surrounding an outside of the planar heating pipe where an outlet is formed, and an open lower surface;
a first header provided at the upper surface to form a first housing; and
a second header provided at the other end of the planar heating pipe and the open lower surface to form a second hosing where an inlet coupled with the other end of the planar heating pipe is formed,
wherein the first housing is a space defined by an inner surface of the first header and the upper surface of the hot water tank, and
the second housing is a space defined by an outer surface of the planar heating pipe, an inner surface of the hot water tank, and an inner surface of the second head.

2. The water heater using a planar heating element of claim 1, wherein the planar heating pipe includes:
a first pipe whose outer surface is coated with the planar heating material;
a first electrode strip including a first ring, which has a broken ring shape and is coated on the planar heating material;
a second electrode strip including a second ring, which has a unbroken ring shape and is coated on the planar heating material; and
a second pipe surrounding the first pipe, the planar heating material, the first electrode strip, and the second electrode strip.

3. The water heater using a planar heating element of claim 2, wherein the first electrode strip further includes a first strip coated on the outer surface of the first pipe to extend the first ring to the other end of the planar heating pipe, and
the second electrode strip further includes a second strip coated on the outer surface of the first pipe to extend the second ring to the other end of the planar heating pipe.

4. The water heater using a planar heating element of claim 2, further comprising a ceramic material coated to at least one of an inner surface and an outer surface of the planar heating pipe,
wherein the ceramic material includes at least one of silica (SiO₂), isopropyl alcohol (IPA), distilled water (H₂O), zirconia (ZrO₂), a black inorganic pigment, and a white inorganic pigment.

5. The water heater using a planar heating element of claim 4, wherein the ceramic material includes silica of 30 to 40 wt %, isopropyl alcohol (IPA) of 15 to 25 wt %, distilled water (H₂O) of 15 to 20 wt %, zirconia (ZrO₂) of 5 to 7 wt %, the black inorganic pigment of 3 to 5 wt %, and the white inorganic pigment of 10 to 15 wt %, and
the composition ratio of the ceramic material is less than 100 wt %.

6. The water heater using a planar heating element of claim 2, wherein the planar heating material includes at least one of metal powder, carbon black, carbon powder, and graphite powder.

7. A heat exchanger using a planar heating element comprising:
a first heat transfer pipe and a second heat transfer pipe whose outer surfaces are coated with a planar heating material;
a first connection plate having a first hole connected to one end of the first heat transfer pipe and a second hole connected to one end of the second heat transfer;
a second connection plate having a third hole connected to the other end of the first heat transfer pipe and a fourth hole connected to the other end of the second heat transfer pipe;
a third connection plate being in contact with the first connection plate, having a fifth hole corresponding to the first hole; and
a fourth connection plate being in contact with the second connection plate, having a first groove corresponding to the third hole and the fourth hole.

8. The heat exchanger using a planar heating element of claim 7, wherein the first groove is formed at the fourth connection plate so that water flowing in the first heat transfer pipe flows in the second heat transfer pipe through the third hole and the fourth hole.

9. The heat exchanger using a planar heating element of claim 8, wherein the first connection plate further has a fifth hole, and
the third connection plate further has a second groove corresponding to the second hole and the fifth hole.

10. The heat exchanger using a planar heating element of claim 9, further comprising a third heat transfer pipe connected to one end of the fifth hole.

11. The heat exchanger using a planar heating element of claim 10, wherein the second groove is formed at one side of the third connection plate so that water flowing in the second heat transfer pipe flows in the third heat transfer pipe through the second hole and the fifth hole.

12. The heat exchanger using a planar heating element of claim 11, wherein the first heat transfer pipe includes:
a pipe whose outer surface is coated with the planar heating material;
a first electrode strip including a first ring which has a ring shape and is coated on the planar heating material; and
a second electrode strip including a second ring which a ring shape and is coated on the planar heating material.

13. The heat exchanger using a planar heating element of claim 12, wherein the first electrode strip further includes a first strip coated at the outer surface of the pipe to be extended in a length direction of the first heat transfer pipe, and
the second electrode strip further includes a second strip coated at the outer surface of the pipe to be extended in the length direction of the first heat transfer pipe.

14. The heat exchanger using a planar heating element of claim 8, further comprising a ceramic material coated to at least one of an inner surface and an outer surface of the planar heating pipe,
wherein the ceramic material includes at least one of silica (SiO₂), isopropyl alcohol (IPA), distilled water (H₂O), zirconia (ZrO₂), a black inorganic pigment, and a white inorganic pigment.

15. The heat exchanger using a planar heating element of claim 14, wherein
the ceramic material includes silica of 30 to 40 wt %, isopropyl alcohol (IPA) of 15 to 25 wt %, distilled water (H₂O) of 15 to 20 wt %, zirconia (ZrO₂) of 5 to 7 wt %, the black inorganic pigment of 3 to 5 wt %, and the white inorganic pigment of 10 to 15 wt %, and
the sum of the composition ratios of material is less than 100 wt %.

16. The heat exchanger using a planar heating element of claim 8, wherein the planar heating material includes at least one of metal powder, carbon black, carbon powder, and graphite powder.

17. A planar heating pipe comprising:
a first pipe whose outer surface is coated with a planar heating material;
a first electrode strip which has a ring shape and includes a first ring coated on the planar heating material;
a second electrode strip which has a ring shape and includes a second ring coated on the planar heating material; and
a second pipe surrounding the first pipe, the planar heating material, the first electrode strip, and the second electrode strip.

18. The planar heating pipe of claim 17, wherein the first electrode strip further includes a first strip coated on the outer surface of the first pipe to extend the first ring to the other end of the planar heating pipe, and
the second electrode strip further includes a second strip coated on the outer surface of the first pipe to extend the second ring to the other end of the planar heating pipe.

19. The planar heating pipe of claim 17, further comprising a ceramic material coated to at least one of an inner surface and an outer surface of the planar heating pipe,
wherein the ceramic material includes at least one of silica (SiO₂), isopropyl alcohol (IPA), distilled water (H₂O), zirconia (ZrO₂), a black inorganic pigment, and a white inorganic pigment.

20. The planar heating pipe of claim 19,
wherein the ceramic material includes silica (SiO₂) of 30 to 40 wt %, isopropyl alcohol (IPA) of 15 to 25 wt %, distilled water (H₂O) of 15 to 20 wt %, zirconia (ZrO₂) of 5 to 7 wt %, the black inorganic pigment of 3 to 5 wt %, and the white inorganic pigment of 10 to 15 wt %, and
the sum of the composition ratios of material is less than 100 wt %.
